(19) United States
(12) Patent Application Publication
(10) Pub. No.: US 2024/0416242 A1
(43) Pub. Date: Dec. 19, 2024

(54) GAME SYSTEM, GAME METHOD, AND GAME PROGRAM

(71) Applicant: The Pokémon Company, Tokyo (JP)

(72) Inventors: Kaname KOSUGI, Tokyo (JP); Sho FURUTANI, Tokyo (JP); Yuki TERADA, Tokyo (JP); Marie SHUTO, Tokyo (JP); Koya NAKAHATA, Tokyo (JP); Takumi TSUKADA, Tokyo (JP)

(73) Assignee: The Pokémon Company, Tokyo (JP)

(21) Appl. No.: 18/818,631

(22) Filed: Aug. 29, 2024

Related U.S. Application Data
(63) Continuation of application No. PCT/JP2022/044798, filed on Dec. 5, 2022.

(30) Foreign Application Priority Data
Mar. 1, 2022 (JP) 2022-031262

(51) Int. Cl. A63F 13/58

(52) U.S. Cl. CPC A63F 13/58

(57) ABSTRACT

A game system, game method, and game program enables a user to look forward to waking up and going to bed. A game system includes a sleep information receiving section that receives sleep information of a user; a placement receiving section that receives a setting of an object that is able to be placed in a field and is associated with a parameter in response to an operation of the user before sleep; a character determination section that determines a display character that is a character to be displayed in the field on the basis of at least sleep information of the user and a parameter of the object; an image generation section that generates a display image indicating a situation of the field including the object placed in the field and the display character; and an output section that outputs the display image after the user wakes up.

### CROSS-REFERENCE TO RELATED APPLICATIONS

This application is a continuation of International Application No. PCT/JP2022/044798, filed Dec. 5, 2022, which claims priority to JP 2022-031262, filed Mar. 1, 2022, the entire contents of each are incorporated herein by reference.

### TECHNICAL FIELD

The present disclosure relates to a game system, a game method, and a game program. More specifically, the present disclosure relates to a game system, a game method, and a game program using information related to sleep of a user.

### DESCRIPTION OF RELATED ART

In the related art, an information processing system that executes an application and includes acquisition means for acquiring user information for calculating information related to sleep of a user, sleep identification means for identifying a state related to the sleep of the user on the basis of the acquired user information and processing execution means for executing predetermined information processing of the application in conjunction with the state related to the sleep of the user is known (see PTL 1, for example). According to the information processing system described in PTL 1, it is possible to simplify a user's operation performed on a system that measures information related to the user's health.

### CITATION LIST

### Patent Literature

[PTL 1] WO 2016/021235

### SUMMARY

### Technical Problems

However, although the information processing system described in PTL 1 can execute predetermined processing on the basis of user's health information, the information processing system requires the user who has just woken up to play a mini game in order to awaken the user on the assumption of presentation of details of the user's health information, for example. In other words, according to the information processing system described in PTL 1, the user is awakened through a passive action for the user. Therefore, according to the information processing system described in PTL 1, it is difficult to allow the user to wake up in the morning with a feeling of excitement.

Therefore, an object of the present disclosure is to provide a game system, a game method, and a game program that enable a user to look forward to waking up and go to sleep.

### Solutions to Problems

Accordingly, the present disclosure provides a game system in which a character is able to appear in a field inside of a game, the game system including: a sleep information receiving section that receives sleep information of a user; a placement receiving section that receives a setting of an object that is able to be placed in the field and is associated with a parameter in response to an operation of the user before sleep; a character determination section that determines a display character that is a character to be displayed in the field on the basis of at least the sleep information of the user and the parameter of the object; an image generation section that generates a display image indicating a situation of the field including the object placed in the field and the display character; and an output section that outputs the display image after the user wakes up.

### Advantageous Effects

According to the game system, the game method, and the game program of the present disclosure, it is possible to provide a game system, a game method, and a game program that enable a user to look forward to waking up and go to sleep.

### BRIEF DESCRIPTION OF DRAWINGS

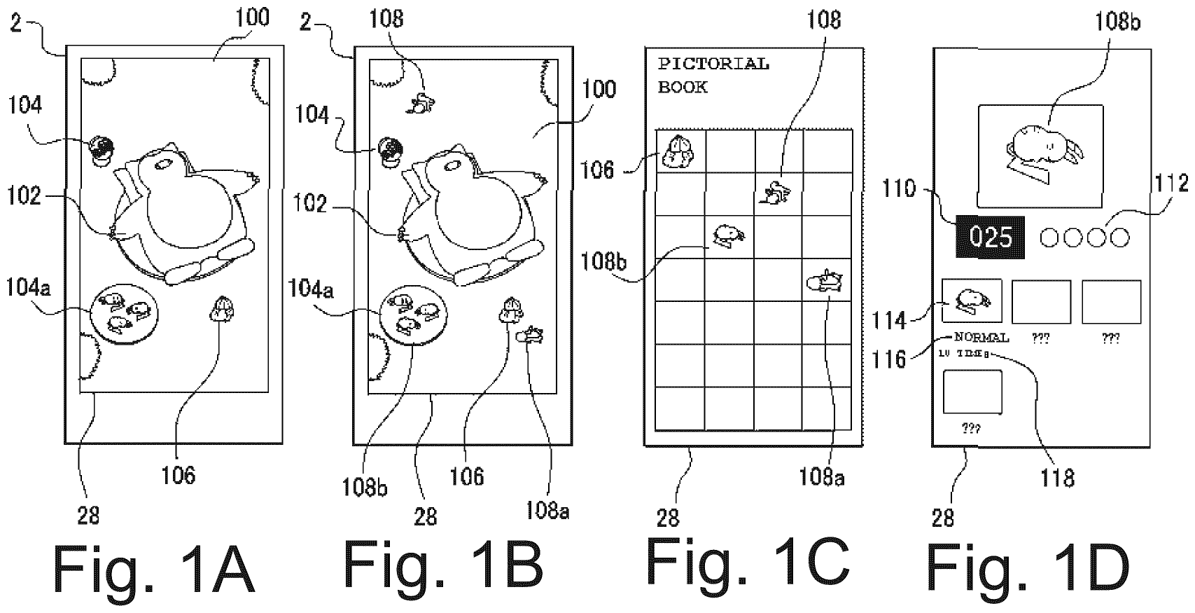

### [FIGS. 1A, 1B, 1C, and 1D]

FIG. 1A, FIG. 1B, FIG. 1C, and FIG. 1D illustrate a schematic view of a game system according to the present embodiment.

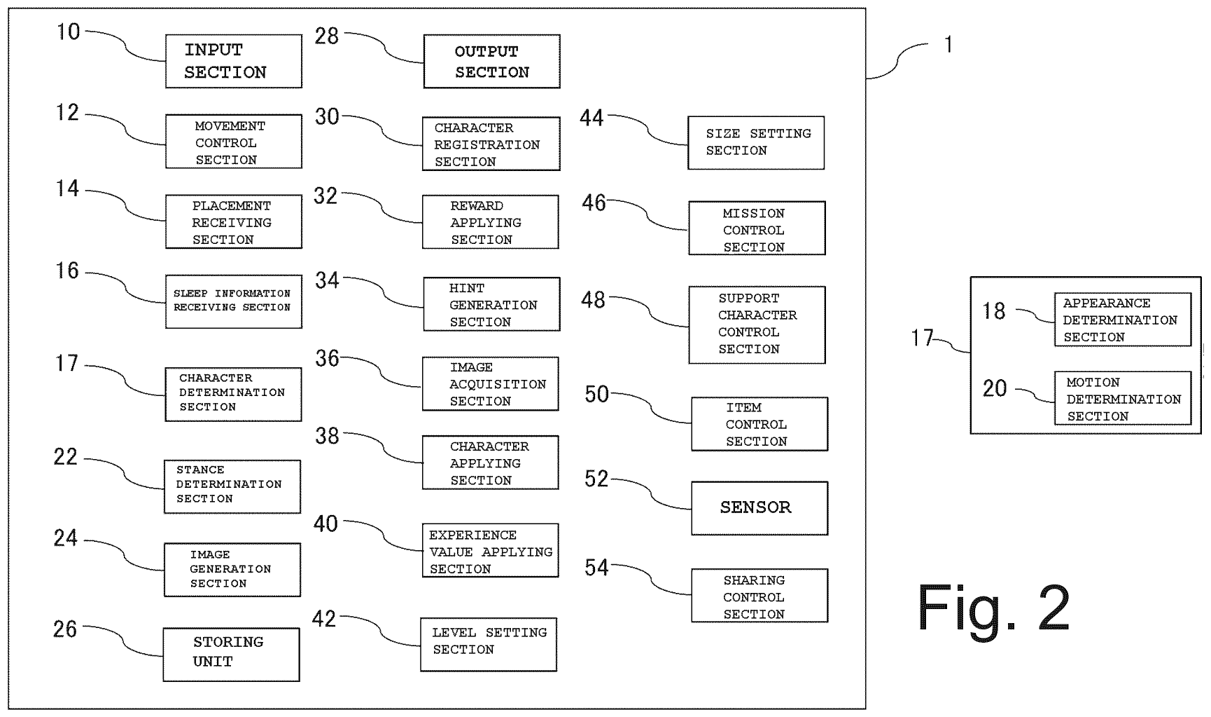

FIG. 2 is a block diagram of a functional configuration of the game system according to the present embodiment.

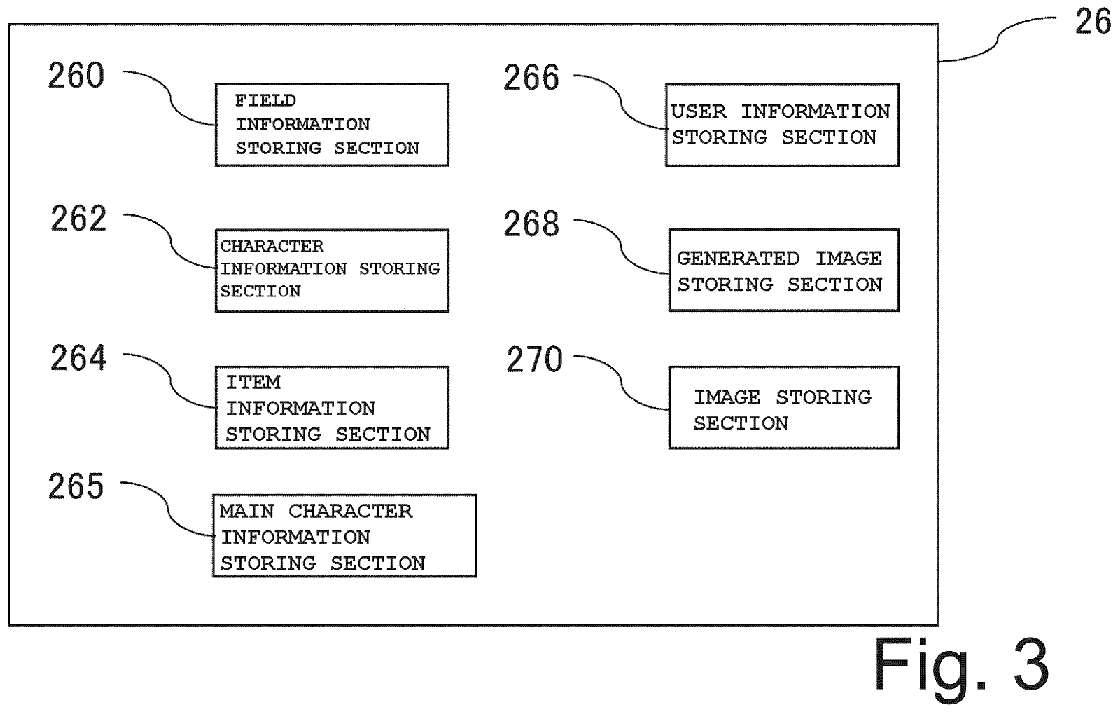

FIG. 3 is a functional configuration block diagram of a storing unit included in the game system according to the present embodiment.

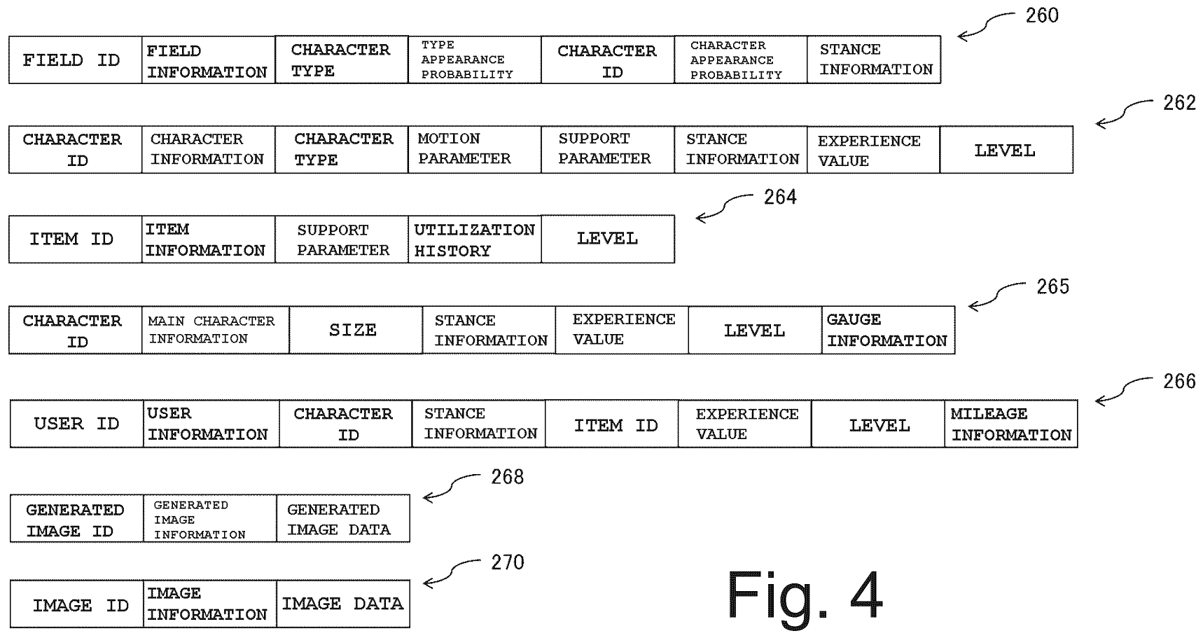

FIG. 4 is a diagram of a data configuration in each storing section included in the present embodiment.

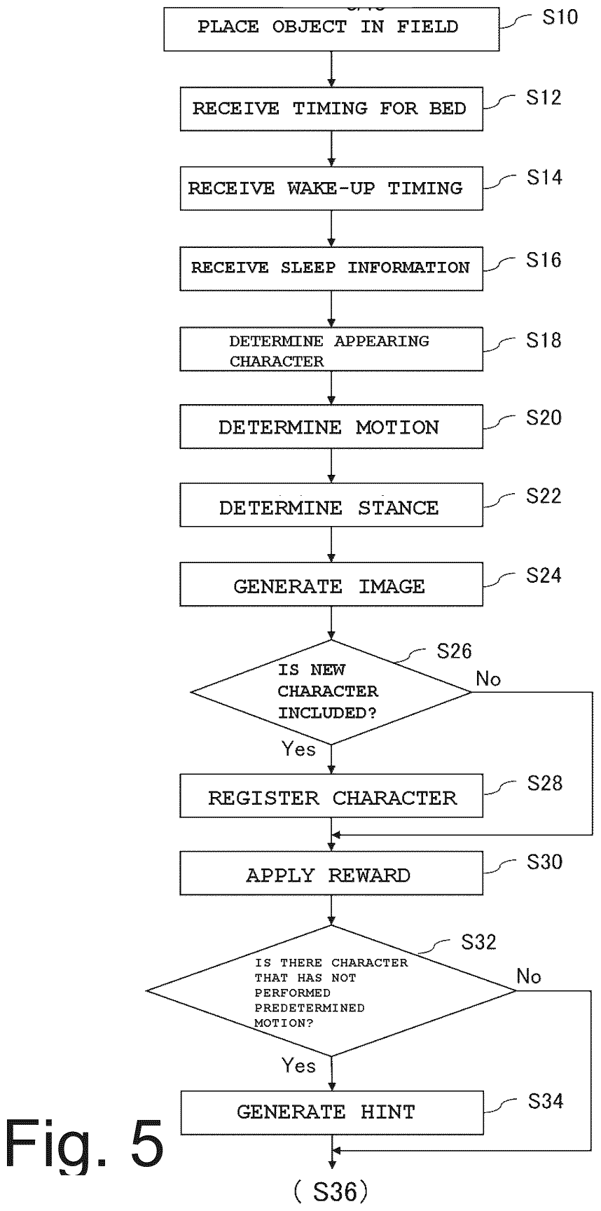

FIG. 5 is a flowchart showing processing performed in the game system according to the present embodiment.

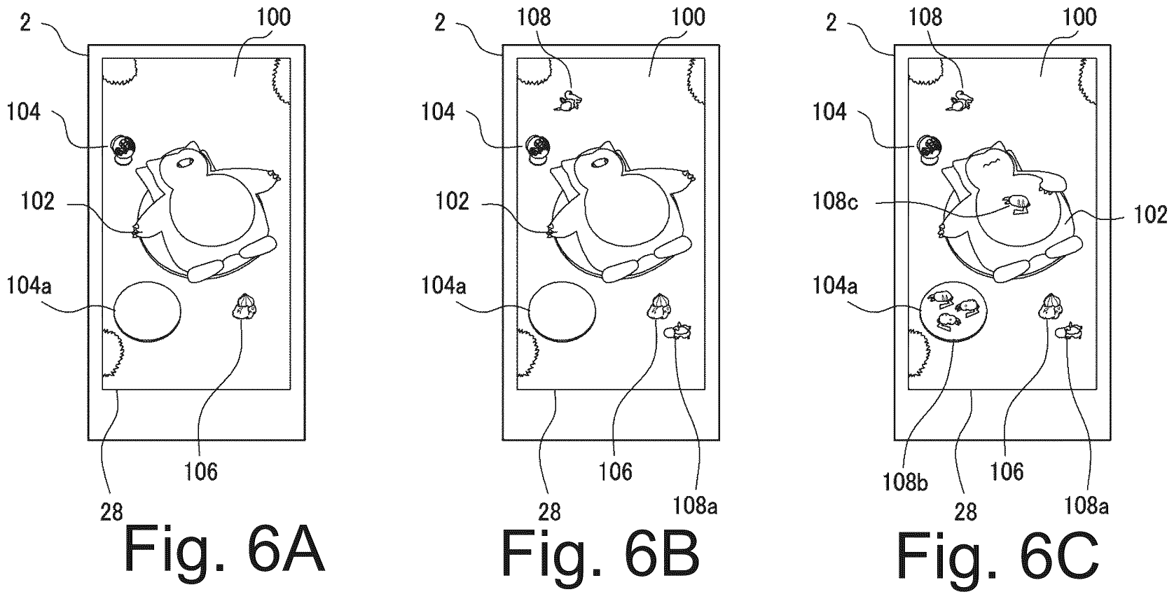

### [FIGS. 6A, 6B, and 6C]

FIG. 6A, FIG. 6B, and FIG. 6B illustrate a diagram of a video generated by an image generation section according to the present embodiment.

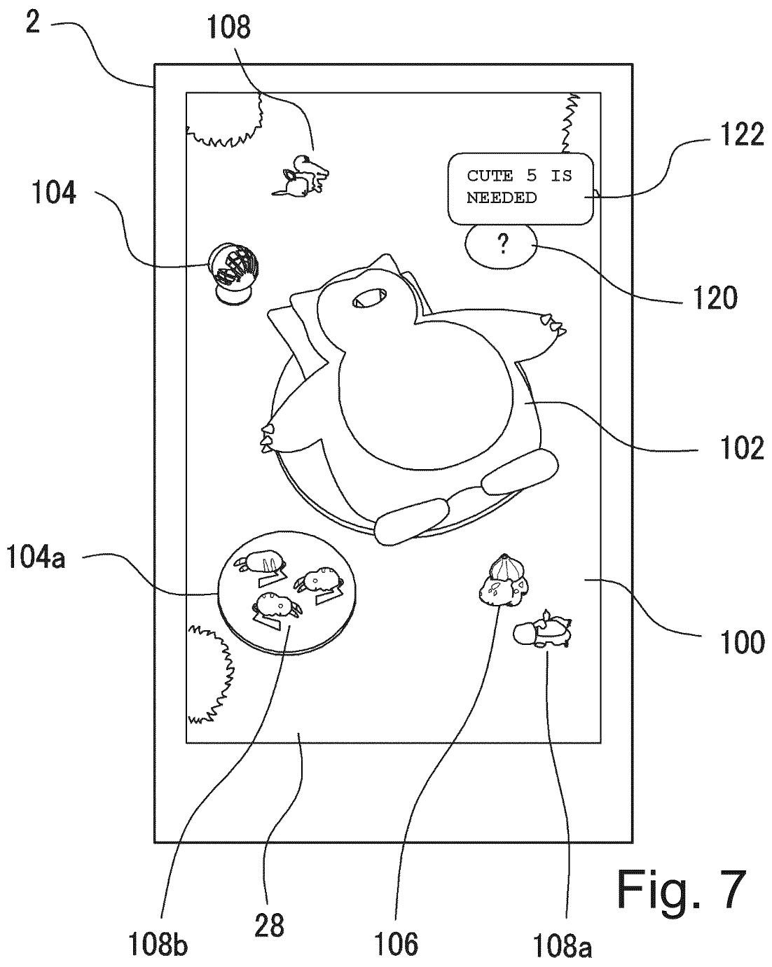

FIG. 7 is a diagram of a video generated by the image generation section and a hint generation section according to the present embodiment.

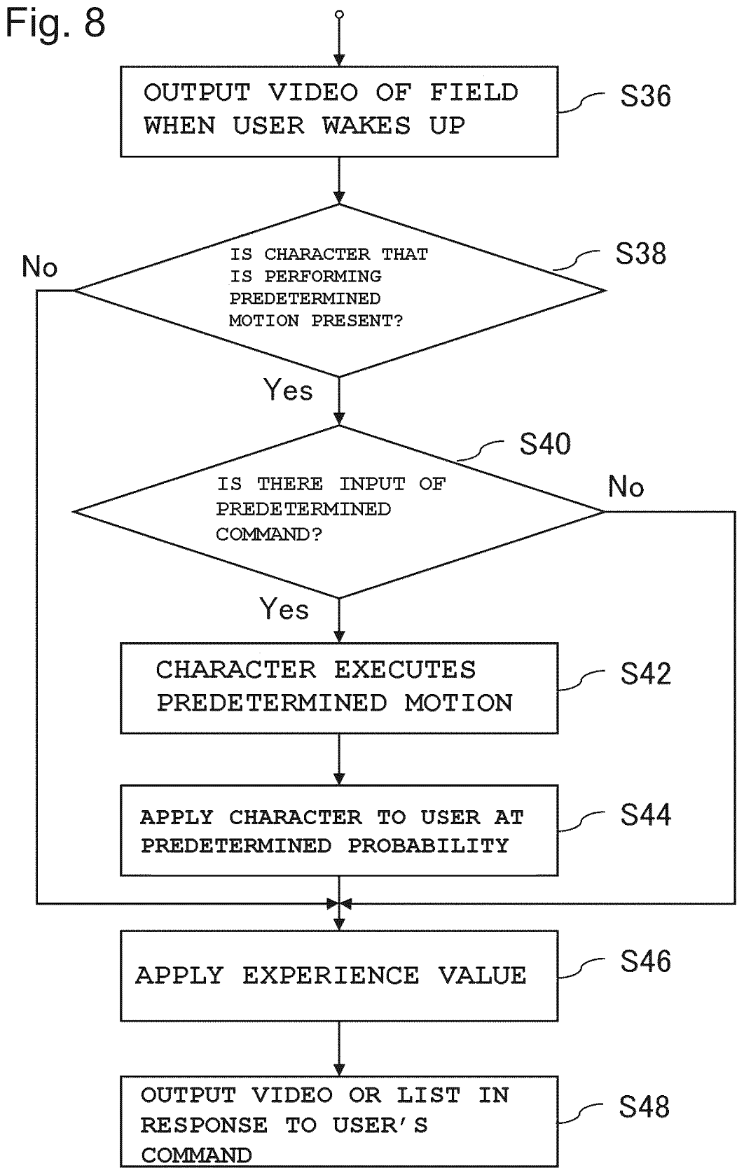

FIG. 8 is a flowchart illustrating processing performed in the game system according to the present embodiment.

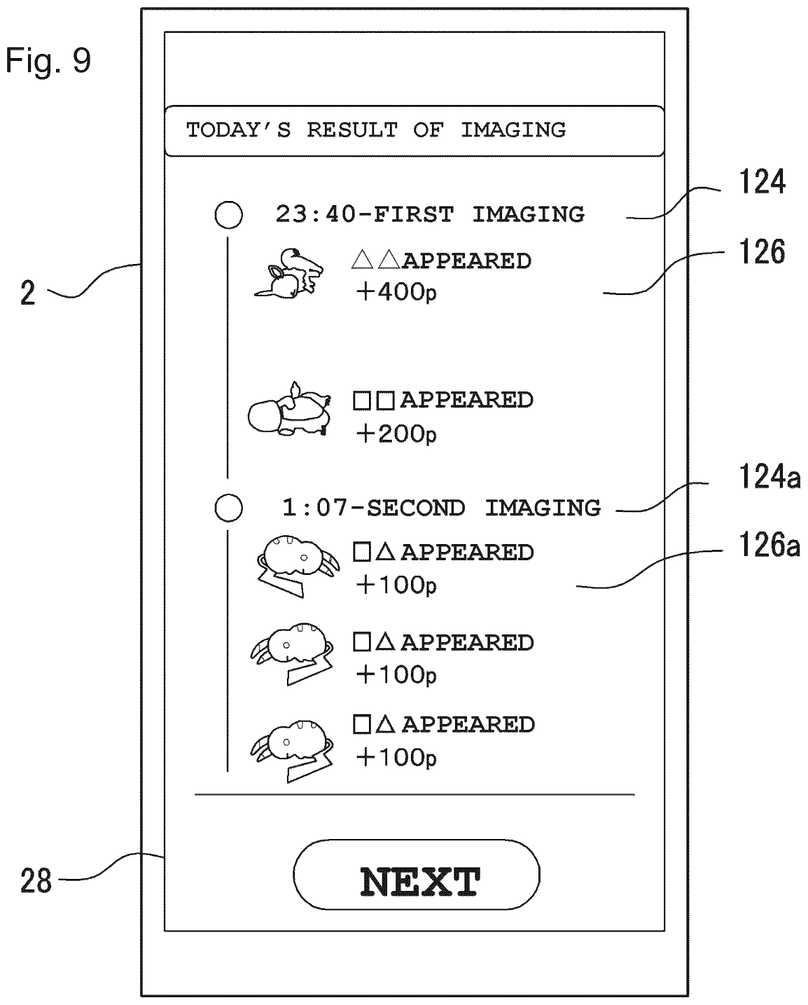

FIG. 9 is a diagram displaying a list of characters according to the present embodiment.

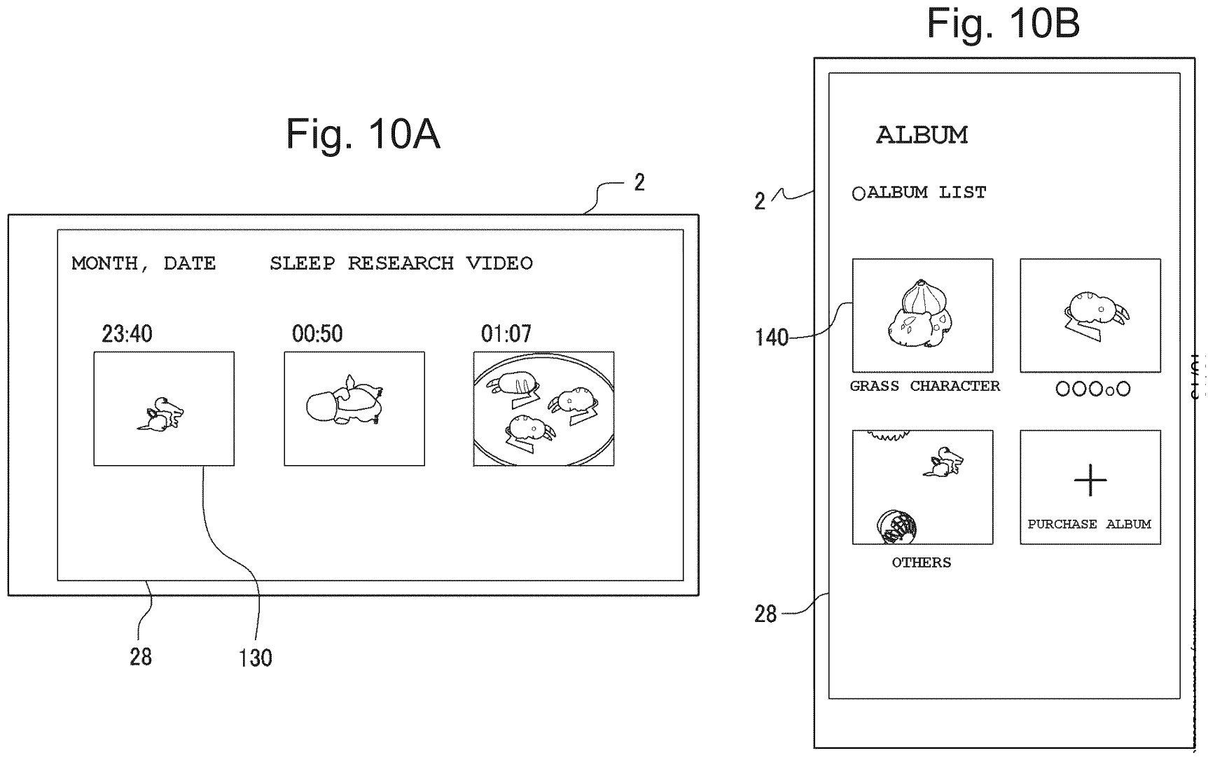

### [FIGS. 10A and 10B]

FIG. 10A and FIG. 10B illustrate a video selection screen and an image selection screen according to the present embodiment.

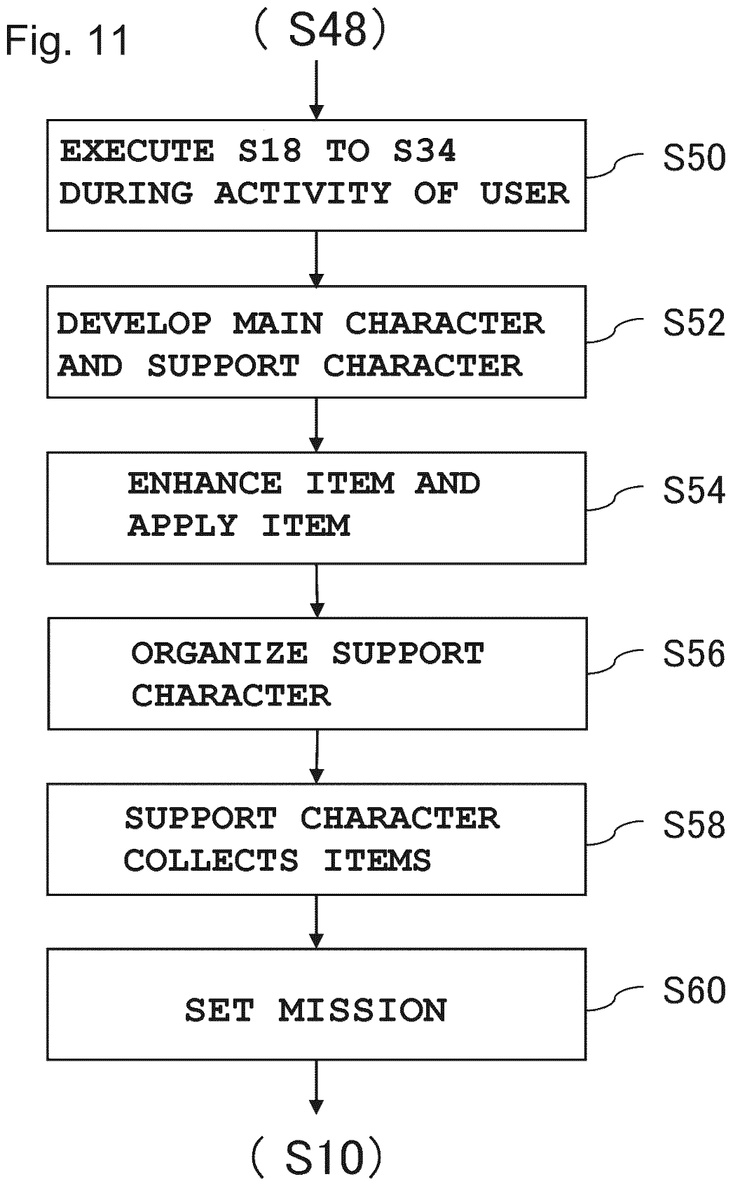

FIG. 11 is a flow diagram of a game system when a user is awakened.

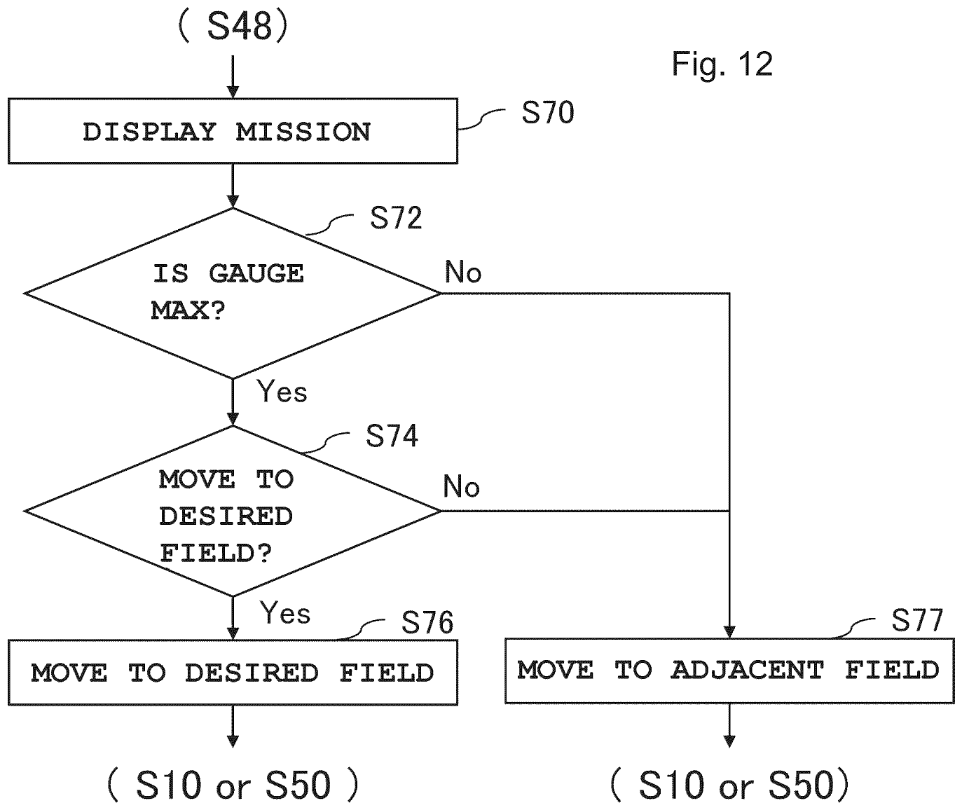

FIG. 12 is a flow diagram of control processing of a movement control section according to the present embodiment.

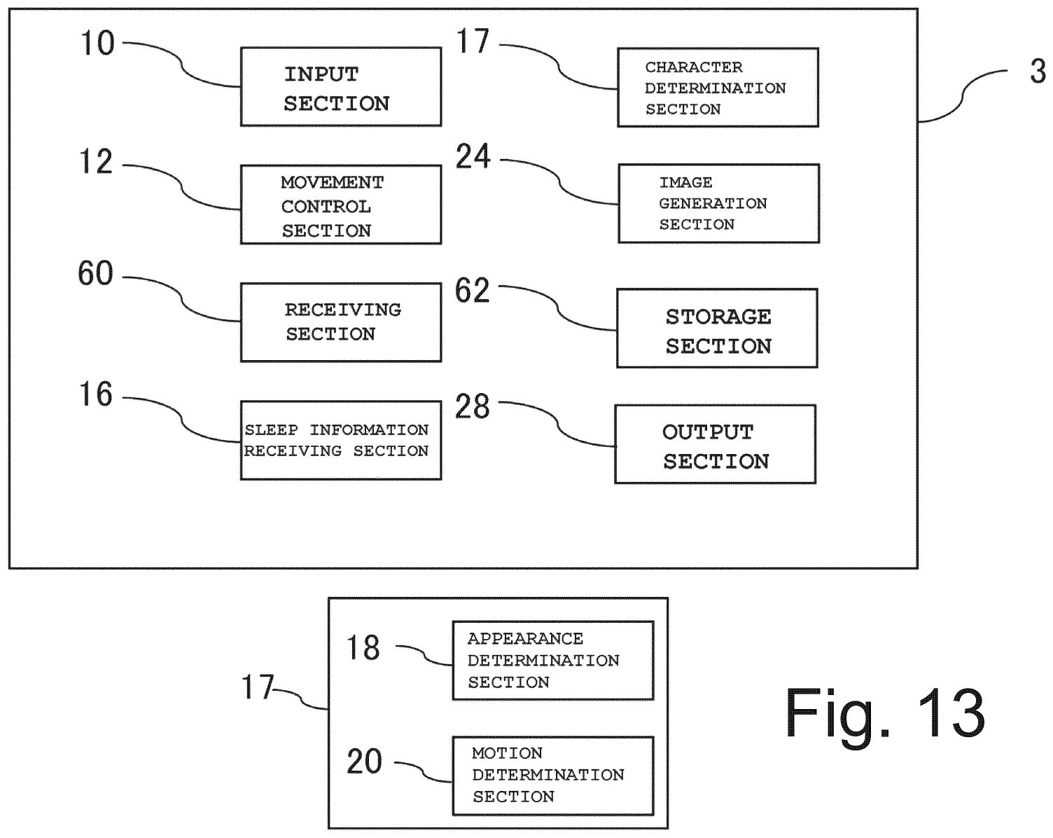

FIG. 13 is a diagram of a part of a functional configuration block of a game system according to a modification example of the present embodiment.

### DETAILED DESCRIPTION

### Embodiment

### <Overview of Game System 1>

A game system 1 according to the present embodiment is a game system in which a variety of characters appear in each of a plurality of fields included in a map inside of a game using sleep information of a user, the appearing characters take a stance that is interesting to the user, and the state can be output and/or recorded as a video or a still image. According to the game system 1, the user can observe the video or the still image after he/she gets up.

For example, the user operates a user character representing the user inside of the game and moves (travels) with a main character to a desired field in the map inside of the game. Then, the game system 1 receives a command of the user and places or arranges a predetermined object (for example, a predetermined item, a support character that supports the user character in the game, or the like) in the field as a destination of the movement. Then, the user goes to sleep. Here, each character is associated with a character type representing features of the character, and each field is associated with a character type of a character that is likely to appear in the field in accordance with features of the field. Also, each object is associated with a predetermined parameter. Furthermore, each character is associated with a predetermined parameter that is minimally required for execution of a predetermined motion in the field.

The game system 1 receives sleep information which is information related to actual sleep of the user. The sleep information is, for example, a sleep time. The game system 1 receives the sleep information from a device or the like that acquires the sleep information from the bedtime to the wake-up time of the user. Then, the game system 1 determines a character that has appeared during sleep of the user on the basis of the sleep time acquired after the user wakes up, a character type of a field, and a character type of the character. In other words, the game system 1 determines the character that has appeared in the field after the user wakes up as if the character had appeared in the field during the sleep of the user rather than determining the character appearing in the field during the actual sleep of the user.

Also, the game system 1 compares a predetermined parameter of the character that has appeared in the field with a predetermined parameter of an object placed or arranged in the field and determines whether or not the character that has appeared has executed a predetermined motion (a sleep motion, for example) on or around a main character. The game system 1 determines whether or not the character has executed the predetermined motion after the user wakes up as if the character had executed or had not executed the predetermined motion during the sleep of the user rather than determining the predetermined motion during the actual sleep of the user. Then, the game system 1 generates a video including a character that has carried out the predetermined motion together with the main character in the field to which the user character has moved from among characters that have appeared in the field during sleep of the user. Here, a character in a sleeping state can take a variety of sleeping positions and sleeping postures on the basis of predetermined information associated with the field and the like. The user can check what kind of motion the character that has appeared in the field has carried out by referring to the video generated by the game system 1 after the user wakes up.

In other words, the game system 1 generates a video including a state in which a sleeping character that is a character having appeared in the field is sleeping in a predetermined sleeping position or sleeping posture on or around a main character in response to a predetermined input operation of the user after the user wakes up, and enables the video to be displayed on a display section of an information terminal or the like. Note that more characters can sleep on or around the main character as the size of the main character increases. The game system 1 can record such a state as a video and/or a still image.

According to the game system 1, the user can observe a variety of motions (for example, sleeping positions or sleeping postures) of a variety of characters the next morning when the user wakes up by devising patterns of combinations of features of fields and objects to be placed or arranged in the fields in a variety of manners before sleep or during daytime and going to sleep. In other words, according to the game system 1, the user can travel with the main character inside of the game and also actually sleep and enjoy traveling inside of the game of observing and studying the predetermined motion of the characters appearing in the field and changing in accordance with the sleep time of the user the next morning after the user wakes up. According to the game system 1, it is also possible to generate, as a video, a state where the user character is sleeping together with the main character and to thereby make the user feel as if the character had appeared around the user and had slept when the user was actually sleeping.

FIG. 1 illustrates an overview of the game system according to the present embodiment. In the example of FIG. 1, an example in which an information terminal 2 executes a game and an output section 28 (a display section of the information terminal 2, for example) displays content of the game is illustrated. FIG. 1A illustrates an example of a state of a field 100 before the user goes to sleep, and FIG. 1B illustrates an example of a state of the field 100 after the user wakes up. Also, FIG. 1C illustrates an example of a pictorial book of collected images of characters, and FIG. 1D illustrates an example of enlarged characters that are registered in the pictorial book.

According to the game system 1, the user selects the predetermined field 100 included in a map inside of the game before sleep. Then, the game system 1 arranges a main character 102 traveling together with the user character inside of the game at a predetermined location in the field 100 as illustrated in FIG. 1A (for example, the main character 102 in a sleeping state is arranged near the center of the output section 28 in the example in FIG. 1). Also, in the game system 1, the user selects an object to be placed in the field 100 in the next sleep at a timing before sleep, and places the object at a desired position in the field 100. The object is, for example, a predetermined item (a fan-shaped item 104 and a mat-shaped item 104a in the example in FIG. 1) or a support character supporting the user character in the game (a support character 106 in the example in FIG. 1).

Then, the game system 1 acquires a timing for bed and a waking-up timing of the user on the basis of an input from the user to the information terminal 2 or information related to a motion of the user acquired by an acceleration sensor or the like that the information terminal 2 has, for example, and calculates a sleep time of the user from the acquired timing for bed and waking-up timing. Subsequently, the game system 1 determines characters appearing in the field 100 during sleep of the user (hereinafter, referred to as “appearing characters”).

Here, a variety of terrains, cities, and the like are represented on the map inside of the game, and fields that the user character and the main character 102 can drop by and fields where the user character and the main character 102 can sleep inside of the game are set at a variety of locations inside of the map. Then, a field type that is attributable to the terrain or the like is set for each field. Examples of the field type include a grass field, a wetland, a forest, a volcano, a beach, a city, a cemetery, and the like. Also, a character type is set for each character, and for a character appearing in a field, how likely the character is to appear in the field is determined depending on a relationship between the field type and the character type. Examples of the character type include a normal type, a grass type, a flame type, a water type, an electricity type, a ghost type, and the like, and setting is made such that a character of a flame type is likely to appear in a field of a volcano type and a character of a ghost type is likely to appear in a field of a cemetery type.

The game system 1 determines characters that have appeared in the field 100 on the basis of the type of the field 100. In a case where the type of the field 100 is a wetland, for example, it is possible to set frequencies at which characters of the water type, the normal type, and the electricity type appears in the field 100 to be high (in an example, it is possible to make a setting such that the characters are more likely to appear in the order of the water type, the normal type, and the electricity type). In other words, it is possible to associate the field 100 with predetermined character types and appearance frequencies thereof in the game system 1. Here, the game system 1 increases the number of times it has been determined whether the characters of the character types associated with the field 100 have appeared in the field 100 during the sleep of the user in accordance with the length of the sleep time, for example.

Then, the game system 1 determines a motion of the characters that have appeared in the field 100. The game system 1 compares the parameter of the object placed in the field 100 with a parameter of each appearing character and determines a motion of the appearing character by drawing a lottery on the basis of the comparison result. In a case where the type of the parameter of the appearing character coincides with the type of the parameter of the object placed in the field 100 and the amount of the parameter of the character is equal to or less than the amount of the parameter of the object, for example, the game system 1 determines whether or not to cause the appearing character to execute a predetermined motion at a predetermined probability. On the other hand, in a case where the type of the parameter of the appearing character does not coincide with the type of the parameter of the object, or in a case where the amount of the parameter of the character exceeds the amount of the parameter of the object even though the type of the parameter of the appearing character coincides with the type of the parameter of the object, or the like, the game system 1 causes the appearing character to leave the field 100 without causing the appearing character to perform the predetermined motion.

For example, the game system 1 causes a character 108, a character 108a, and a plurality of characters 108b to appear in the field 100 in the example in FIG. 1B. Here, it is assumed that “three” parameters “P1” are associated with the character 108, “two” parameters “P1” are associated with the character 108a, and “one” parameter “P1” and “three” parameters “P2” are associated with the characters 108b.

Also, it is assumed that “four” parameters “P1” are associated with the item 104, and “three” parameters “P2” are associated with the support character 106. In this case, total numbers of the parameters associated in the object (the item 104 and the support character 106) inside of the field 100 are “four” for the parameters “P1” and “three” for the parameters “P2”. Note that the parameters “P1” and the parameters “P2” are mutually different types of parameters.

Then, the game system 1 compares the parameter of each character with parameters of all the objects placed or arranged in the field 100. In the example in FIG. 1B, both the types and the amounts of the parameters of the characters 108 to 108b are within the ranges of the types and the amounts of all the parameters associated with the objects inside of the field 100. Therefore, the game system 1 determines a sleeping motion, for example, as a motion of these characters by drawing a lottery and generates a video including a state in which each elected character is sleeping.

On the other hand, in a case where “five” parameters “P1” are associated or a type of parameters “P3” that are different from the parameters “P1” and “P2” is associated with a different character, or the like, the type and/or the amount of the parameters of the different character are outside of the range of the types and/or the amounts of all the parameters associated with the objects in the field 100. In this case, the game system 1 causes the different character to execute a motion of leaving the field 100. Note that characters that have not been elected in the drawing of a lottery for the motion are also similarly caused to execute the motion of leaving.

Then, the game system 1 stores the generated video in a predetermined storing section. Also, the user can check what kinds of characters the characters that have appeared in the field 100 and characters that have slept during sleep of the user are and what kinds of postures the characters have slept in by referring to the video that the game system 1 stores in the predetermined storing section through the information terminal 2 after the user wakes up.

Also, the game system 1 can record characters that have appeared in the field 100 for the first time in the pictorial book as illustrated in FIG. 1C. For example, the game system 1 can output the support character 106 that the user has placed in the field 100 for the first time and the characters that have appeared in the field 100 for the first time (for example, the character 108, the character 108a, and the characters 108b) to predetermined positions in the output section 28 of the information terminal 2 in the form of the pictorial book. Moreover, the game system 1 can also display each of the characters recorded in the pictorial book in an enlarged manner in response to an operation of the user as illustrated in FIG. 1D. In this case, the game system 1 may apply a serial number 110 to each character and display the serial number 110 in the vicinity of the image of the character. In the example in FIG. 1D, for example, the game system 1 receives a selection command for the character 108b in the pictorial book from the user, displays the image of the character 108b in an enlarged manner, and displays the serial number 110 in the vicinity of the image and the name 112 of the character. Also, the game system 1 may display another image 114 acquired for each type of a sleeping position or sleeping posture taken by the character 108b for sleeping, for example, together with a type name 116 of the sleeping posture or a sleeping position of the character in the image 114, and the number of times 118 the imaging has been performed hitherto (that is, the number of appearances) on a screen on which the enlarged image of the character 108b is displayed.

In this manner, the game system 1 determines the characters appearing in the field 100 on the basis of the type of the field, the character type, and the sleep time and determines the motion of the field 100 of the appearing characters on the basis of the parameters of the objects and the parameters of the appearing characters. The motion is, for example, a motion of the characters sleeping or a motion of leaving the field 100 without sleeping. Then, in a case where the characters carry out the sleeping motion, it is also possible to change the sleeping positions or sleeping postures depending on the type of the field, the parameters of the objects, and the like. Therefore, the user can devise a combination of selection of a desired field and arrangement of various objects in a variety of manners from the viewpoint of appearance of desired characters and what kind of sleeping stance of the desired characters the user desires to observe. In this manner, the user considers and devises in what kind of environment the characters that may appear in the field 100 can more easily sleep in a variety of manners when the user is awakened by repeating actual sleep, can thereby gradually recognize it, and can organize the environment (sleep environment) in which the characters sleep inside of the game. Then, the user cannot easily anticipate what kind of characters will sleep and what kind of stances the characters will take as a result of the user himself/herself devising the combination when the user gets into bed, the user thus desires to definitely check it when the user wakes up, and the user can thus wake up with a feeling of excitement.

Furthermore, the sleep information (for example, the sleep time, quality of the sleep, and the like) cannot be freely controlled by the user and actually cannot be freely controlled in general. In other words, if user tries to have desired sleep (sleep for a predetermined period of time and sleep with predetermined quality), the user cannot have the intended sleep in many cases depending on the body conditions, everyday stress, content of his/her life, and the like of the user. Therefore, if the game result is generated on the basis of the sleep information, it is not possible to obtain a game result that the user desires in many cases, and motivation to continuously play the game diminishes. In this manner, the game using the sleep information has a problem that the persistence rate of the game is low regardless of the game having a characteristic that information accuracy typically improves with continuous acquisition of health information including the sleep information.

However, the game system 1 generates a game screen by taking advantage of elements that the user can control on the basis of ideas of the user himself/herself, such as selection of a field and selection of objects to be placed in the field, in addition to the sleep information (in other words, images of predetermined characters are displayed together with predetermined objects in a predetermined field). Also, the user can recognize that user's selection influences the game although the user cannot recognize how the devise before sleep influences the game screen in advance, and it is thus possible to provide interest and a fun only for the sleep game that the user can enjoy without getting bored. Furthermore, the user can easily recognize influences of the setting before waking up on the game screen through the game screen after waking up when the characters are displayed together with the field selected by the user and the objects placed in the field on the game screen. Note that since it is more difficult for the user to freely control quality of sleep, in particular, as compared with the sleep time, only the sleep time may be used as the sleep information without using information regarding the quality of sleep. In this manner, the user can further enjoy the game without getting bored (however, the sleep information is assumed to include the sleep time, the quality of sleep, and the like in the following description unless particularly stated otherwise).

Note that the game system 1 can be realized by a mobile communication terminal, an information terminal such as a smartphone, a laptop PC, a tablet PC, a PC, a mobile game machine, and/or a home game machine, or the like. However, from the viewpoint of easiness of acquisition of information related to going to bed and waking up of the user, the game system 1 is preferably a mobile communication terminal, a smartphone, a small-sized tablet terminal, or the like or may be a combination of a wearable device that is connected to the above various information terminals in a wired or wireless manner or an information acquisition device including a sensor that acquires the user's body information and the above various information terminals. In addition, while details of the game system 1 according to the present embodiment will be described below, it is to be understood that names, numerical values, and the like in the description given above and the description given below are merely exemplary, that the present disclosure is not limited to such names, numerical values, and the like, and that such names, numerical values, and the like are not necessarily related to actual names, numerical values, and the like.

### <Details of Game System 1>

FIG. 2 illustrates an example of a functional configuration of the game system according to the present embodiment, and FIG. 3 illustrates an example of a functional configuration of a storing unit included in the game system according to the present embodiment. Also, FIG. 4 illustrates an example of a data configuration in each storing section included in the present embodiment.

The game system 1 according to the present embodiment is a game system 1 in which characters can appear in a field inside of a game, selection of a field for next sleep made before sleep of the user and a setting of objects to be placed in the field are received, characters to appear in the field are determined using a sleep time of the user in the next sleep in accordance with an operation of the user after waking up from the next sleep, and parameters of the field, parameters of the objects, and parameters of characters are compared to determine a motion of characters that satisfy a predetermined condition.

### [Overview of Configuration of Game System 1]

The game system 1 includes: an input section 10 that receives a predetermined command; a movement control section 12 that controls movements of characters inside of the game; a placement receiving section 14 that receives a command of placing objects and the like; a sleep information receiving section 16 that receives information related to sleep of the user; a character determination section 17 that determines display characters that are characters to be displayed in the field; a stance determination section 22 that determines postures of characters, an image generation section 24 that generates an image (a video and/or a still image) including a situation of the field; a storing unit 26 that stores various kinds of information; and the output section 28 that outputs the image and the like. Here, the character determination section 17 includes an appearance determination section 18 that determines appearing characters that are characters to appear in the field and a motion determination section 20 that determines motions of the appearing characters. In addition, the game system 1 can also include: a character registration section 30 that stores the characters and the like that have appeared in the field in a predetermined storing section; a reward applying section 32 that applies a reward to the user or the like; a hint generation section 34 that generates a predetermined hint; an image acquisition section 36 that acquires a video constituting image that constitutes a video; a character applying section 38 that applies a character to the user; an experience value applying section 40 that applies an experience value to the user or the like; a level setting section 42 that sets levels of the characters and the like; and a size setting section 44 that sets a size of the main character.

Furthermore, the game system 1 may include: a mission control section 46 that performs presentation or the like of a predetermined mission inside of the game for the user; a support character control section 48 that controls motions and the like of the support character; an item control section 50 that controls motions and the like of items inside of the game; a sensor 52 that detects motions and the like of the user; and a sharing control section 54 that uploads a video and the like to a predetermined external server. Moreover, the storing unit 26 includes a field information storing section 260 that stores information related to fields; a character information storing section 262 that stores information related to characters; an item information storing section 264 that stores information related to items; a main character information storing section 265 that stores information related to the main character; a user information storing section 266 that stores information related to the user; a generated image storing section 268 that stores generated images; and an image storing section 270 that stores images.

Examples of the sensor 52 include an illuminance sensor, an acceleration sensor, a gyro sensor, a temperature sensor, a humidity sensor, an air pressure sensor, a noise sensor, an odor sensor, and/or a biosensor. In the present embodiment, it is possible to use an acceleration sensor as the sensor 52 from the viewpoint of simply recognizing going to bed and waking up of the user.

Instead of only physically having the plurality of components described above in a same apparatus or at a same place, the game system 1 may place a part of the plurality of components described above at a physically separated position. For example, the game system 1 may have an external server to bear a part of the functions of the components. In this case, the game system 1 is configured of an information terminal, an external server, and if needed, a device including a sensor that acquires sleep information of the user. In addition, the game system 1 may be configured as one or more servers. In this case, the game system 1 is configured by combining an information terminal, components of one server, and components of another server. Furthermore, in the present embodiment, an aggregation of predetermined components can be recognized as one “information processing apparatus”, and the game system 1 may be formed as an aggregation of a plurality of information processing apparatuses. A method for distributing the plurality of functions required to realize the game system 1 according to the present embodiment to one or a plurality of pieces of hardware can be determined as appropriate in consideration of the processing capacity of each piece of hardware and/or the specifications required of the game system 1, and the like. Note that various kinds of information stored in the storing unit 26 may be updated by an instruction by a user or information accepted via the input section 10 or updated as need by acquiring predetermined information from a predetermined server which is present outside of the game system 1.

### [Details of Configuration of Game System 1]

In the following explanation, a case where the game provided by the game system 1 is executed mainly by the user using the information terminal 2 will be explained as an example. Note that although components are not particularly limited from the viewpoint of smoothly executing processing of the game, it is also preferable that the placement receiving section 14, the appearance determination section 18, the motion determination section 20, the stance determination section 22, and/or the image generation section 24 be executed by an external server connected to the information terminal 2 via a communication network.

### (Storing Unit 26)

The storing unit 26 stores various kinds of information related to the game. Each storing section included in the storing unit 26 supplies predetermined information to a predetermined component in response to a request from another component of the game system 1.

### (Storing Unit 26: Field Information Storing Section 260)

The field information storing section 260 stores field information, character types of characters that may appear in each field, type appearance probabilities, character IDs, character appearance probabilities, and/or stance information in association with field IDs for identifying the fields in the map of the game. The field information is information such as field names (for example, an XX volcano, a YY grass field, and the like), field types that are features of the fields (for example, a volcano, a grass field, and the like), positions of the fields the map, configurations of the fields, and the like. In addition, the character types are information representing character features associated with the characters appearing in the game, and the character IDs are IDs for identifying the characters as will be described later.

Here, the character appearance probability is a probability at which each of the plurality of characters appears in a field. In other words, how likely each character is to appear in the field is set by associating the appearance probability of each character in the field with the field ID. Note that rarity (rareness) information is individually set for each character, and character appearance probabilities of characters with higher rareness are set to be lower than character appearance probabilities of characters with lower rareness such that the characters with higher rareness are less likely to appear.

Also, a type appearance probability may be further associated with each field. The type appearance probability is an appearance probability of all the characters of the character types that are likely to appear in the field identified by the field ID. In other words, how likely each character type is to appear in the field may be set by associating one or more character types and further associating the appearance probability of each character type in the field with the field ID. Note that each character type includes one or more characters having individual natures and it is also possible to associate the character appearance probability with each character. In this case, which character is likely to appear in the field from among characters of a predetermined character type is set by the character appearance probabilities.

The stance information is information related to a stance taken when a character appearing in the field executes a predetermined motion. The stance information includes, for example, information regarding what kind of sleeping position or sleeping posture each character will take in the field and/or information indicating a probability at which the character will take the sleeping position or sleeping posture and the like in a case where the predetermined motion is a sleeping motion.

### (Storing Unit 26: Character Information Storing Section 262)

The character information storing section 262 stores the character information, the character types, motion parameters, support parameters, stance information, experience values, and/or levels in association with the character IDs for identifying the characters. The character information is information related to names, sexes, skills, rareness, and the like of the characters. The character types are information (for example, a normal type, a flame type, and the like) representing features of the characters. Note that examples of the characters include the characters appearing in the field (appearing characters), support characters that support activities of the user inside of the game, and the like. Also, in a case where a character is a support character arranged in the field, it is possible to deal with the character as one kind of an object. In this case, the support parameters of the support character exhibit the same functions as support parameters of an item, which will be described later.

The motion parameters are information indicating the types and/or the amounts of parameters that are minimally necessary to execute a predetermined motion in the field. Also, the support parameters are parameters that are associated with a character ID in accordance with properties and the like of the support character in a case where the character is the support character, and are parameters to be used for comparison with the motion parameters. Note that the motion parameters and the support parameters may be the same or different from each other. In a case where a character has changed to a support character, for example, support parameters may have content taken over from motion parameters or may have changed content. Note that motion parameters of characters with higher rareness may have more types and/or more amounts than motion parameters of characters with lower rareness, or a necessity of utilization of a predetermined consumption item may be associated with the motion parameters of the characters with higher rareness.

Note that the motions include motions in a sleeping state in the field and motions in a state where the characters are awakened in the field. In other words, the motions include, as motions during sleeping, sleeping motions of the characters, sleeping positions or sleeping postures with movement of the characters, and predetermined poses with no movement of the characters (that is, sleeping postures, sleeping positions, or the like of the characters in still images). Note that as the sleeping motions, a plurality of types of sleeping motions (a motion in a sound sleep state, a motion in a dozing-off state, and the like) can be set depending on a depth of sleep, for example. Also, the motions include, as motions in an awakened state, motions that can be observed in a video such as a moving motion inside of the field and a motion of leaving the field, and/or motions that can be observed in a still image such as a state of moving inside of the field and a state of leaving from the field.

Also, the stance information is information indicating what kind of stance each character will take in a case where the character executes the predetermined motion and is, for example, information regarding the sleeping posture, the sleeping position, and the like during sleeping. The stance information can store information regarding a plurality of stances. Also, in a case where information regarding a plurality of stances is included in the stance information, rareness may be associated with each of the information pieces for the plurality of stances. Also, the information regarding a stance with which predetermined rareness has been associated may be associated with an appearance condition of character that executes a motion in the stance (for example, a condition that the character associated with the stance information is to be taken in the video a predetermined number of times or the like). Furthermore, the experience values are values that the characters have gotten in the game, and the levels are numerical values determined in accordance with the sums of the applied experience values and numerical values representing ranks of the characters. Note that in a case where the experience values that the characters have gotten achieve a predetermined condition (for example, in a case where the experience values exceed a prescribed threshold value), it is possible to raise the levels of the characters in a stepwise manner.

Here, although the types of the motion parameters are not particularly limited, the types can be determined in accordance with character types, properties of the characters, and the like. In an example, a motion parameter named “nice and warm” may be associated with characters of the “flame type”, a motion parameter named “flashing” may be associated with characters of the “electricity type”, and a motion parameter named “cool” may be associated with characters of the “water type”. Also, a plurality of types of motion parameters may be associated with one character. Although the types of motion parameters are not particularly limited, other examples include “cute”, “fluffy”, “powerful”, “sparkling” and the like. The character IDs are associated with the amounts of motion parameters in addition to the types of the motion parameters as motion parameters. For example, types of motion parameters and the amounts of the motion parameters of the types (for example, “nice and warm”×5) are associated with a character ID as motion parameters.

### (Storing Unit 26: Item Information Storing Section 264)

The item information storing section 264 stores item information, support parameters as object parameters, a utilization history, and/or levels in association with item IDs for identifying items that are objects. The items are various tools that the user can place in the field 100, various tools that the user can use in the field 100, and the like (hereinafter, these may be referred to as “sleep goods”). Also, the item information is information regarding types, names, characteristics, shapes, and the like of the items. Note that although the items are not particularly limited, examples thereof include items with shapes of a pillow, a blanket, a sitting cushion, a mat, a sheet, a cushion, and the like and shapes of a fan, a paper fan, a stove, an ornament, and the like. Also, the support parameters are parameters associated with item IDs in accordance with properties and the like of the items and are parameters to be used for comparison with motion parameters. Types and amounts of the support parameters are similar to those of the motion parameters described in the explanation of the character information storing section 262. The item IDs are associated with, as the support parameters, the types of the support parameters and the amounts of the support parameters of the types.

Here, the same types as the types of the motion parameters are exemplified as the types of the support parameters. As examples, “nice and warm”, “flashing”, “cool”, “cute”, “fluffy”, “powerful”, “sparkling”, and the like are exemplified as the types of the support parameters. Also, one or more support parameters and the amount of each support parameter are associated with each item similarly to the character. For example, as the support parameters, types of support parameters and amounts of support parameters of the types (for example, “cute”×5 and the like) are associated with each item ID. Moreover, the utilization history is information related to the number of times each item has been used, a time during which the item has been used, and the like inside of the game. In addition, the levels are numerical values determined in accordance with the utilization history and the like and are numerical values representing ranks of items. The game system 1 may change the types and the amounts of the support parameters, for example, in response to level up of an item, may update the types and the amount after the change as new support parameters, and store the new support parameters in the item information storing section 264.

### (Storing Unit 26: Main Character Information Storing Section 265)

The main character information storing section 265 associates main character information, the size, stance information, an experience value, a level, and/or gauge information of the main character in association with the character ID for identifying the main character. The main character information is information related to a name, a sex, skills, and the like of the main character. Also, the size of the main character is information indicating how large the main character is inside of the game, and the stance information is information indicating what kind of stance the main character will take in a case where the main character executes a predetermined motion and is preferably information regarding a sleeping posture or a sleeping position or the like during sleep, in particular, of the main character. The stance information can include information related to a plurality of stances. The experience value and the level are similar to those in the explanation of the character information storing section 262. Moreover, the gauge information is information related to a predetermined parameter value of the main character, and the parameter value increases or decreases in accordance with information such as the sleep time of the user (in an example, the parameter value is increased in accordance with the length of the sleep time). The parameter value of the gauge information may be increased depending on utilization of paid items, for example.

### (Storing Unit 26: User Information Storing Section 266)

The user information storing section 266 stores user information, character IDs of characters and/or a main character that the user owns, stance information of the characters corresponding to the character IDs, item IDs of items that the user owns, an experience value of the user, a level of the user, and/or mileage information in association with the user ID for identifying the user. The user information is a nick name of the user, information (an appearance, a sex, and the like) related to the user character that the user uses inside of the game, information unique to each of the individual users (birth year and date, information regarding favorite foods, and the like), and/or information regarding a reward applied to the user, and the like. Also, the stance information is information indicating the stance such as a sleeping position or sleeping posture or the like of the character of each character ID stored in the user information storing section 266 in association with the user ID. The experience value and the level are similar to those in the explanation of the character information storing section 262. Also, the mileage value is information related to points applied to the user in accordance with the actual sleep information of the user, for example, a sleep time.

### (Storing Unit 26: Generated Image Storing Section 268, Image Storing Section 270)

The generated image storing section 268 stores generated image information related to an image (generated image) generated by the game system 1 and/or generated image data of the generated image in association with a generated image ID for identifying the generated image. The generated image includes a still image and a video. In a case where the generated image is a video, for example, the generated image information is information regarding a year, a date, and an exact clock time, and the like of creation of a video, a video size, hint information related to characters included in the video and characters that have appeared in the field but have not carried out the predetermined motion, and the like. Also, in a case where the generated image is a still image, for example, the generated image information is information regarding a year, a date, and an exact clock time and the like of acquisition of the still image, a still image size, hint information regarding characters included in the still image and characters that have appeared in the field but have not carried out the predetermined motion, and the like. The generated image storing section 268 can store the generated image as an album. In this case, the generated image storing section 268 can provide an upper limit for the number of albums. However, the generated image storing section 268 can also increase the upper limit in exchange for consumption of in-game virtual currency or the like inside of the game.

In addition, the image storing section 270 is a storing section that stores various images (videos and/or still images) to be used by the game system 1 and stores image information and/or image data in association with image IDs for identifying the images. The image information is, for example, names of the images, sizes of the images, and the like.

### (Input Section 10, Output Section 28)

The input section 10 receives inputs of various kinds of information and predetermined commands from the user. The input section 10 is, for example, a touch panel, a keyboard, a mouse, a microphone, a motion sensor, or the like of the information terminal 2. The input section 10 supplies the predetermined commands to predetermined components of the game system 1. The components that have received the predetermined commands exhibit the respective predetermined functions.

The output section 28 outputs results of various kinds of processing executed by the game system 1. The output section 28 outputs various processing results and stored information such that the user can perceive the results and the information. Specifically, the output section 28 outputs the various processing results and the stored information as physical phenomena and the like such as still images, moving images, sound, texts, and/or vibration. For example, the output section 28 is a display section, a speaker, a vibrating section (a device that is provided inside of an information terminal and generates vibration by a predetermined electrical signal), a light emitting section, or the like of the information terminal. Moreover, the output section 28 can also output an image generated by the image generation section 24 in response to a command of the user. Furthermore, the output section 28 can also output various kinds of information stored in the storing unit 26 and/or information received from an external server.

### (Movement Control Section 12)

The movement control section 12 controls movement of the user character indicating the user who executes the game and the main character that acts together with the user character inside of the map of the game in response to a command of the user received via the input section 10. For example, a plurality of fields is provided in the map, and the movement control section 12 causes the user character and the main character to move to one of the fields inside of the map in response to selection of the user when the user is awakened. In this case, the movement control section 12 can cause the user character and the main character to move from the one field to another field that is adjacent to the one field in principle. On the other hand, in a case where the main character is in a specific state (for example, in a case where gauge information of the main character indicates a maximum value or the like), for example, the movement control section 12 may cause the user character and the main character to move from the one field to a field that is not adjacent to the one field and is located at a separated position. In this manner, the user character that the user can operate can act inside of the field as a destination of movement together with the main character that can act in the field together with the user character inside of the game. The movement control section 12 supplies a field ID of the field as the destination of movement to the appearance determination section 18, the character determination section 17, the motion determination section 20, and/or the stance determination section 22.

### (Placement Receiving Section 14)

The placement receiving section 14 receives a setting of an object that can be placed in a field and is associated with a parameter in response to an operation of the user before sleep. For example, the placement receiving section 14 receives a setting of an object to be placed in the field in the next sleep before sleep of the user. In other words, the placement receiving section 14 executes a command of receiving a setting of an object to be placed in the next sleep in the field that the user character and the main character have arrived and a setting of the main character that will move to the field together with the user via the input section 10 in response to the command of the user under control of the movement control section 12 before sleep (typically, during a daytime or in a daytime) of the user. Examples of the object include sleeping goods and/or a support character. Note that the numbers of both the sleeping goods and the support characters to be placed in the field may be one or more. In a case where a plurality of support characters is placed in the field, a deck of the plurality of support characters may be organized. The placement receiving section 14 supplies information related to the objects placed in the field (for example, item IDs, character IDs, and the number of placed items and/or characters) to the character determination section 17, the motion determination section 20, and/or the stance determination section 22.

### (Sleep Information Receiving Section 16)

The sleep information receiving section 16 receives sleep information that is information related to sleep of the user. In other words, the sleep information receiving section 16 receives sleep information in the next sleep of the user. The sleep information receiving section 16 may receive the sleep information from sleep information acquisition means for acquiring the sleep information. Examples of the sleep information include a sleep time, a bedtime, a getting-into-bed time, a falling-asleep time, a wake-up time, an awakening time, and/or quality of the sleep. The sleep information receiving section 16 can receive the sleep information from various known sleep information acquisition means. For example, the sleep information receiving section 16 can receive information detected by the sensor 52 such as an acceleration sensor that the information terminal 2 of the user includes and calculates a sleep time from a timing for bed (for example, a bedtime) to a wake-up timing (for example, a wake-up time) of the user. In an example, it is possible to place the information terminal 2 including the acceleration sensor near a pillow or the like of the user, to define a timing at which the acceleration sensor detects a predetermined state as the timing for bed, and to define a timing at which the acceleration sensor detects a predetermined motion after elapse of a predetermined time as the wake-up timing. Also, in a case where the acceleration sensor measures a motion such as rolling-over of the user during sleep, the sleep information receiving section 16 may receive the measurement result and generate information related to the quality of the sleep. Moreover, the sleep information receiving section 16 may calculate the sleep time from the getting-into-bed time to the wake-up time of the user received via the input section 10. The sleep information receiving section 16 supplies the received sleep information or the generated or calculated sleep information to the character determination section 17, the appearance determination section 18, the stance determination section 22, the image generation section 24, the reward applying section 32, and/or the experience value applying section 40.

Note that the present inventor has found out that the sleep information receiving section 16 cannot necessarily receive strict quality of sleep as a result of examining the quality of sleep using a commercially available information terminal 2 including an acceleration sensor. Thus, acquisition of strict quality of sleep is not required in the present embodiment, the sleep time may be mainly used as the sleep information, and the quality of sleep may be supplementally used from the viewpoint that the user can try the game in a simple manner.

### (Character Determination Section 17)

The character determination section 17 determines a display character that is character to be displayed in the field on the basis of at least the sleep information of the user and parameters of the object. The character determination section 17 determines a display mode of the display character on the basis of the sleep information of the user and the parameters of the object. Specifically, the character determination section 17 determines the display character on the basis of at least the sleep information of the user, the parameters of the object, and parameters of characters associated with the field.

For example, the character determination section 17 determines the display character by drawing a lottery on the basis of the sleep time of the user received from the sleep information receiving section 16. In an example, the character determination section 17 determines the display character to be displayed in the field from the characters stored in the character information storing section 262 by drawing a lottery using character appearance probabilities stored in association with the field in the field information storing section 260. In this case, the character determination section 17 may determine the number of times a lottery is drawn and/or the probability of being elected in accordance with the sleep time of the user. Then, the character determination section 17 compares the parameters of the field and/or the parameters of the object with the parameters of the display character and determines a motion of the display character, which satisfies a predetermined condition on the basis of the comparison result, inside of the field at a predetermined probability. In addition, the character determination section 17 can also determine the clock time the display character has appeared in the field on the basis of the sleep information.

Here, a motion parameter that is a condition required to execute any motion from among a predetermined plurality of types of motions (including at least either a moving motion or a standing-still motion) of the character in the field is associated with the character. The character determination section 17 acquires the motion parameter of the display character stored in association with the character ID in the character information storing section 262. Then, the character determination section 17 can compare a parameter of an object that is present in the field with the motion parameter of the display character and determine a motion (for example, a motion based on stance information stored in the character information storing section 262 in association with the character ID of the display character) of the display character. In a case where the motion parameter coincides with the parameter of the object or is included in the parameter of the object as a result of the comparison, for example, the character determination section 17 determines a predetermined motion from among a plurality of types of motions as a motion of the display character. Specifically, the character determination section 17 can determine a display mode of the display character on the basis of information regarding the appearing character determined by the appearance determination section 18 and the information regarding the motion of the appearing character determined by the motion determination section 20. Note that the display character indicates the appearing character determined by the appearance determination section 18, the motion of which is determined by the motion determination section 20.

### (Appearance Determination Section 18)

The appearance determination section 18 determines an appearing character that is a character to appear in the field on the basis of the sleep time of the user in the next sleep. In other words, the appearance determination section 18 determines the appearing character by drawing a lottery using the sleep time received from the sleep information receiving section 16. The appearance determination section 18 executes a lottery for the appearing character a predetermined number of times determined in accordance with the sleep time. The appearance determination section 18 starts the lottery in response to a predetermined input of the user who has woken up. Also, the appearance determination section 18 may increase the probability that a character with higher rareness is elected as the sleep time increases.

Specifically, the appearance determination section 18 acquires character types, type appearance probabilities, character IDs, and character appearance probabilities stored in the field information storing section 260 in association with the field ID received from the movement control section 12. Then, the appearance determination section 18 draws a lottery (first lottery) for which character type is to be selected for appearance of a character from the character types and the type appearance probabilities associated with the field ID first. In this manner, the character type for appearance in the field is determined. Next, the appearance determination section 18 draws a lottery (second lottery) for which character is to be caused to appear from among one or more characters included in the character type from the character IDs of the characters included in the character type and the character appearance probabilities corresponding to the character IDs after the character type for appearance is determined. In this manner, the appearance determination section 18 determines the appearing character. Note that the appearance determination section 18 may determine the appearing character only through the second lottery without determining the character type.

Then, the appearance determination section 18 executes the first lottery and the second lottery the number of times determined in accordance with the sleep time. For example, the appearance determination section 18 can execute the first lottery and the second lottery by defining the number obtained by dividing the sleep time by a unit time as the number of times (a fraction is rounded down or rounded off). In an exemplary case where the sleep time is 8 hours and the unit time is set to 2 hours, the appearance determination section 18 can execute four sets of lotteries if the first lottery and the second lottery are set as one set of lotteries. In other words, the number of times the first lottery and the second lottery are executed increases as the sleep time increases. In this manner, the number of characters appearing in the field increases. As a result, the number of characters that are caused to execute a predetermined motion by the motion determination section 20, which will be described later, also increases, and the number of characters that the character applying section 38 applies to the user also increases. Note that the number of times the first lottery and the second lottery are executed by the appearance determination section 18 is several times a day although it depends on the setting of the unit time.

In addition, the appearance determination section 18 may determine a clock time when the appearing characters have appeared in the field (in other words, the clock time is not an actual clock time but is a clock time in the past). In other words, the appearance determination section 18 carries out the first lottery and the second lottery after the sleep time is acquired, that is, after the user wakes up. Thus, the appearance determination section 18 separately determines the clock time when the appearing characters have appeared in the field in a case where the appearing characters are determined. The appearance determination section 18 can randomly determine the clock time when the appearing characters have appeared in the field or can determine the clock time in accordance with the character type of the appearing characters, the motion parameters, and the like. The appearance determination section 18 supplies the information related to the determined appearing characters to the character determination section 17, the motion determination section 20, the stance determination section 22, the image generation section 24, the reward applying section 32, and/or the hint generation section 34.

Note that the appearance determination section 18 may split the sleep time into a predetermined unit time and determine characters appearing in the field in each split time in response to a command of the user who wakes up after the next sleep. In other words, the appearance determination section 18 may execute the first lottery and the second lottery for each split time. In this case, the appearance determination section 18 may determine the clock time corresponding to each split time as a clock time when the appearing characters have appeared. In a case where the sleep time is 8 hours, and the unit time is 2 hours, for example, the appearance determination section 18 carries out each of the first lottery and the second lottery four times. In this case, the appearance determination section 18 defines each lottery as having been carried out 2 hours, 4 hours, 6 hours, and 8 hours after the user went to bed and determines the clock time at which each appearing character has appeared in the field. In a case where the user goes to bed at 11:00 pm and wakes up at 7:00 am, for example, the appearing clock time of the appearing characters is determined as any clock time out of 1:00 am, 3:00 am, 5:00 am, and 7:00 am although the appearance determination section 18 carries out the lottery after the user wakes up.

### (Motion Determination Section 20)

The motion determination section 20 compares parameters of the field and/or the parameters of the object with the parameters of the appearing characters in response to an operation of the user after waking up from the next sleep and determines a motion of an appearing character that satisfies a predetermined condition at a predetermined probability on the basis of the comparison result.

The motion determination section 20 acquires support parameters stored in the character information storing section 262 in association with the character ID (that is, the character ID of the support character) that is information related to the objects received from the placement receiving section 14 and/or support parameters stored in the item information storing section 264 in association with the item ID that is information related to the object. In addition, the motion determination section 20 acquires motion parameters stored in the character information storing section 262 in association with the character IDs of the appearing characters received from the appearance determination section 18. Then, the motion determination section 20 compares the support parameters of the item and/or the support character with the motion parameters of the appearing characters.

Specifically, the motion determination section 20 recognizes the types and the amounts of the support parameters (hereinafter, referred to as “object parameters” in some cases) of the items and/or the support characters and recognizes the types and the amounts of the motion parameters of the appearing characters. Then, the motion determination section 20 determines a motion of the appearing characters at a predetermined probability in a case where (a) or (b) below is satisfied. Note that the motion determination section 20 determines a motion of leaving the field as the motion of the appearing characters in a case where both (a) and (b) below are not satisfied. In this case, the motion determination section 20 also determines the clock time at which the leaving motion is executed.

(a) in a case where the type of the motion parameters and the type of the object parameters coincide with each other, and the amount of the motion parameters is equal to or less than the amount of the object parameters. In a case where there are a plurality of types of motion parameters and a plurality of types of object parameters, a case where the plurality of types of the object parameters that are present and the plurality of types of the motion parameters that are present coincide with each other, and the amount of each of the plurality of types of motion parameters is equal to or less than the amount of each of the corresponding plurality of types of object parameters.

(b) In a case where there are a plurality of types of object parameters, a case where the plurality of types of object parameters that are present include the types of the motion parameters, and all of the amounts of the motion types of the types included in the types of the object parameters are equal to or less than the amounts of the object parameters.

For example, the motion determination section 20 categorizes the object parameters for each type and recognizes the amount of each type. In a case where the motion determination section 20 determines that “nice and warm” (the amount of which is, for example, “3”) and “sparkling” (the amount of which is, for example, “1”) are present as support parameters of items, and “nice and warm” (the amount of which is, for example, “1”) and “cool” (the amount of which is, for example, “2”) are present as support parameters of the support character, for example, the motion determination section 20 determines that the “nice and warm” parameters are present by the amount of “4”, the “sparkling” parameters are present by the amount of “1”, and the “cool” parameters are present by the amount of “2” in the field.

Also, the motion determination section 20 recognizes motion parameters of the appearing characters for each of the appearing characters. For example, an example in which three appearing characters are present will be described. In an example, it is assumed that an operation parameter of a first appearing character is “nice and warm” (the amount of which is, for example, “4”), motion parameters of a second appearing character are “nice and warm” (the amount of which is, for example, “4”) and “sparkling” (the amount of which is, for example, “5”), and a motion parameter of a third appearing character is “sparkling” (the amount of which is, for example, “1”). In this case, the motion determination section 20 determines that the “nice and warm” parameter is associated with the first appearing character by the amount of “4”, the “nice and warm” parameter and the “sparkling” parameter are associated with the second appearing character by the amount of “4” and the amount of “5”, respectively, and the “sparkling” parameter is associated with the third appearing character by the amount of “1”.

In this case, the motion determination section 20 determines that the motion parameters of the first appearing character and the third appearing character satisfy the above condition (a) or (b) since the “nice and warm” parameter is present by the amount of “4”, the “sparkling” parameter is present by the amount of “1”, and the “cool” parameter is present by the amount of “2” in the field, and determines that the motion parameter of the second appearing character does not satisfy both the above conditions (a) and (b) (in other words, although the amount of the “nice and warm” parameter of the second appearing character coincides with the amount of the “nice and warm” parameter in the field, the amount of the “sparkling” parameter exceeds the amount of the “sparkling” parameter in the field).

Also, in a case where the predetermined condition (the condition (a) or (b) in the above example) is satisfied, the motion determination section 20 determines a motion of the appearing characters at a predetermined probability (in other words, a lottery is drawn in a case where the predetermined condition is satisfied, and the appearing characters are caused to execute the predetermined motion in a case where the appearing characters are elected). In other words, the motion determination section 20 determines, by drawing a lottery, whether or not to cause the first appearing character and the third appearing character to execute the predetermined motion in the field. In a case of being elected, the motion that the motion determination section 20 causes the appearing character to execute is, for example, a motion of the appearing character moving inside of the field and/or a motion of the appearing character sleeping inside of the field (sleeping motion). In this case, the motion determination section 20 may cause the display character to perform the sleep motion on or around or in the vicinity of the main character in the field, that is, at a position within a predetermined range centered on the main character. On the other hand, in a case of being not elected, the motion that the motion determination section 20 causes the appearing character to execute is a motion of leaving the field without sleeping, for example. The motion determination section 20 supplies information indicating content of the determination to the character determination section 17, the stance determination section 22, the image generation section 24, the character registration section 30, the reward applying section 32, and/or the hint generation section 34.

Note that the motion determination section 20 may determine the motion of the appearing characters without drawing a lottery (in other words, without determining the motion of leaving the field as a motion of the appearing character) and may cause the appearing characters to execute the predetermined motion in the case where the predetermined condition (the condition (a) or (b) in the above example) is satisfied. Also, the motion determination section 20 may determine the motion of the appearing characters by drawing a lottery and may cause the appearing characters to execute the predetermined motion in a similar manner in a case where either (c) or (d) below is satisfied as well.

(c) in a case where the type of the motion parameters and the type of the object parameters coincide with each other and the amount of the motion parameters is less than the amount of the object parameters

(d) in a case where there are a plurality of types of object parameters, the plurality of types of object parameters that are present include the types of the motion parameters, and the amounts of all the types of motion parameters included in the types of the object parameters are less than the amount of the object parameters.

In a case where a motion parameter of a fourth appearing character is “sparkling” (the amount of which is, for example, “5”), and the amount of the “sparkling” parameter in the field is “5”, for example, the motion determination section 20 determines a motion of the appearing character by drawing a lottery. On the other hand, in a case where the amount of “sparkling” parameter in the field is “10”, for example, the motion determination section 20 may determine that the appearing character is to be caused to perform the motion regardless of the lottery (or may make a determination by drawing a lottery with 100% probability of being elected).

Note that the character determination section 17 can determine a display mode of the display character on the basis of information received from the appearance determination section 18 and the motion determination section 20. In this case, the character determination section 17 supplies the information indicating content of the determination made by the motion determination section 20 and information related to the appearing characters determined by the appearance determination section 18 to the stance determination section 22, the image generation section 24, the character registration section 30, the reward applying section 32, and/or the hint generation section 34. Hereinafter, an example in which each of the appearance determination section 18 and the motion determination section 20 supplies predetermined information to predetermined components will be explained.

### (Stance Determination Section 22)

The stance determination section 22 determines a stance (for example, a sleeping position or sleeping posture) of each appearing character that has been determined to perform the sleeping motion by the motion determination section 20 on the basis of the sleep time of the user, an elapse time from the bedtime of the user, an actual clock time, quality of the sleep of the user, stance information associated with the field ID, item information associated with the item ID, and/or stance information associated with the character ID of the support character. Moreover, the stance determination section 22 can also determine the stance of the support character and/or the main character in the field 100 on the basis of the sleep time of the user, the elapse time from the bedtime of the user, the actual clock time, the quality of the sleep of the user, the stance information associated with the field ID, the item information associated with the item ID, the stance information associated with the character ID of the support character, and/or the stance information associated with the character ID of the main character. Moreover, in a case where the sleep information received by the sleep information receiving section 16 includes quality of the sleep of the user (for example, information related to a stage of the sleep such as a light sleep state or a deep sleep state), the stance determination section 22 may change the stance (for example, a sleeping posture or a sleeping position during sleeping) of the main character 102 in accordance with the quality. In other words, the game system 1 can apply a change in image (an image of the entire field) or an atmosphere of the image of the field by changing the stance of the main character 102 in accordance with the quality of the sleep although the game system 1 does not execute acquisition of an image including only the stance of the main character 102 unlike the case of the display character in principle. In this manner, the game system 1 may supplementally use the quality of sleep.

For example, the stance determination section 22 can determine to cause the character that has been determined to perform the sleeping motion to take a predetermined sleeping position or sleeping posture on the basis of the stance information stored in the field information storing section 260 in association with the field ID received from the movement control section 12. Also, the stance determination section 22 may determine to take the predetermined stance on the basis of an interaction between another character that has been determined to perform the sleeping motion and is present around the object placed or arranged in the field and/or the character that has been determined to perform the sleeping motion and the character that has been determined to perform the sleeping motion. The stance determination section 22 supplies information indicating content of the determination to the image generation section 24, the character registration section 30, and/or the reward applying section 32.

### (Image Generation Section 24)

The image generation section 24 generates a display image indicating a situation of a field including an object placed in the field and a display character. The display image generated by the image generation section 24 is a still image and/or a video. For example, the image generation section 24 can generate a video having a length determined in accordance with a sleep time and indicating a situation of a field 100 including at least either an appearing character that has appeared in the field 100 or an appearing character, a motion of which has been determined. Note that the image generated by the image generation section 24 is conceptually a video acquired by causing an imaging device that keeps the field in an imaging region to successively perform a recording operation during sleep of the user and/or a still image captured by the imaging device. Also, the image is a video and/or a still image that picks up a timing when a character has appeared in the field and/or a timing at which the appearing character has executed a predetermined motion and enables viewing of the timing. In a case where a user's command of selecting a character included in the video and/or the still image is received, the image generation section 24 may cause an image of the character to be displayed in an enlarged manner and generate a several-second video including the character displayed in the enlarged manner. Hereinafter, an exemplary case in which the image generated by the image generation section 24 is a video will be mainly explained.

Specifically, the image generation section 24 generates an image including a state where the appearing character determined by the appearance determination section 18 executes an operation determined by the motion determination section 20 and/or a state where the character executes the motion determined by the motion determination section 20 and also takes a stance determined by the stance determination section 22. Moreover, in a case where a video is generated, the image generation section 24 can also set the length of the video to be generated to be shorter than a sleep time calculated from a bedtime and a wake-up time of the user included in sleep information of the user received from the sleep information receiving section 16 at a predetermined proportion in accordance with the sleep time or can also generate a video of a digest version.

Here, the image generation section 24 can generate a plurality of videos in one-time sleep of the user. In other words, a video with a predetermined length including one or more appearance times of appearing characters determined by the appearance determination section 18 and/or each of one or more execution times of the motion of the appearing characters that have executed the motion determined by the motion determination section 20 from among the appearing characters. In a case where the appearance determination section 18 determines that the characters have appeared at a clock time t₁, a clock time t₂, a clock time t₃, . . . and a clock time tₙ (where n is a positive integer), the image generation section 24 may generate videos including the clock time t₁, the clock time to, the clock time t₃, . . . , and the clock time tₙ and having a predetermined length (which is preferably equal to or less than several minutes from the viewpoint of allowing the user to easily view the video) including a predetermined time before and after each clock time and a thumbnail image at each clock time. In this manner, the image generation section 24 is not required to generate a video for the entire sleep time and can generate a video including the timings at which the characters have appeared in the field 100 and the timings at which the appearing characters have performed a sleeping motion.

In addition, the image generation section 24 may provide a plurality of split parts obtained by splitting the time from the bedtime to the wake-up time into a plurality of parts of a predetermined time and generate a video, a digest video, or a still image of a digest version for each split part. For example, the image generation section 24 can generate a plurality of videos by generating a video from the bedtime to a clock time after elapse of the predetermined time and then repeating the motion of generating a video from the clock time to a clock time after elapse of the predetermined time until the wake-up time. Therefore, the image generation section 24 generates more videos as the sleep time is longer or as the time of each split part is shorter. Note that each of the plurality of videos may be a video including the timing at which the character has appeared in the field 100 and the timing at which the appearing character has performed the sleep motion and including the predetermined time before and after the timings.

In addition, the image generation section 24 can also generate a video indicating a situation of the field at the time of waking up after the user wakes up and generate a video of a state in which the appearing character sleeping in the field wakes up in response to an input operation of the user. The generated video is output from the output section 28. Furthermore, the image generation section 24 may generate a video by changing a field environment in accordance with an actual time zone. For example, the image generation section 24 may generate a video by changing a background image of the field to a night field, a morning glow field, a morning field, and a daytime field in accordance with the actual time zone. Moreover, the image generation section 24 can also acquire information regarding quality of sleep of the user at a predetermined clock time from the sleep information receiving section 16 as sleep information, generate a video including the predetermined clock time, and include the information (for example, text information, information represented by a drawing such as a graph, and the like) indicating the quality of the sleep of the user (for example, a stage of the sleep) in the video.

The image generation section 24 supplies the generated image to the generated image storing section 268. The generated image storing section 268 stores generated image data of the generated image along with generated image information in association with a generated image ID. Note that the generated image information may be information including the bedtime, the wake-up time, the date of sleep, and the like of the user when the generated image is generated, for example. Also, the image generation section 24 supplies the generated display image to the output section 28, and the output section 28 outputs the display image.

### (Character Registration Section 30)

The character registration section 30 stores the character ID of the display character determined by the character determination section 17 and included in the image generated by the image generation section 24 for the first time and/or the character ID of the appearing character that has been determined to execute the sleeping motion by the motion determination section 20 in association with the user ID in the user information storing section 266. Specifically, in a case where the character registration section 30 compares character IDs of characters owned by the user and stored in the user information storing section 266 in association with the user ID with the character ID of the appearing character that has performed the sleep motion determined by the motion determination section 20, and the character ID of the appearing character that has performed the sleep motion is not stored in the user information storing section 266, the character registration section 30 stores the character ID of the appearing character as the appearing character that has newly performed the sleep motion in the user information storing section 266 in association with the user ID.

Also, the character registration section 30 compares the character IDs and stance information of the characters owned by the user and stored in the user information storing section 266 in association with the user ID with the character ID of the appearing character that has performed the sleep motion determined by the motion determination section 20 and the stance of the appearing character determined by the stance determination section 22, and stores the character ID of the appearing character as the appearing character that has newly performed the sleep motion in the user information storing section 266 in association with the user ID even in a case where the character ID of the appearing character that has performed the sleep motion and has taken the stance determined by the stance determination section 22 is not stored in the user information storing section 266. In other words, in a case where characters with the same character ID are in different stances (that is, sleeping postures or sleeping positions) during the sleeping motion, the character registration section 30 can deal the characters as different characters for each of the plurality of stances.

### (Reward Applying Section 32)

The reward applying section 32 applies a predetermined reward to the user. For example, the reward applying section 32 applies a mileage to the user in accordance with a sleep time received by the sleep information receiving section 16. The reward applying section 32 updates mileage information stored in the user information storing section 266 in association with the user ID using information regarding to the mileage determined to be applied to the user. Also, the reward applying section 32 may apply a reward to the user in a case where a character ID of an appearing character determined by the appearance determination section 18 is not stored in the user information storing section 266. Furthermore, the reward applying section 32 may apply a reward to the user even in a case where the character ID of the appearing character determined by the appearance determination section 18 is stored in the user information storing section 266. However, in this case, the amount of reward may be reduced as compared with a case where the character ID is not stored in the user information storing section 266.

Moreover, the reward applying section 32 may apply a reward to the user in a case where the character ID of the appearing character determined to execute the sleeping motion by the motion determination section 20 is not stored in the user information storing section 266. Furthermore, the reward applying section 32 may apply a reward to the user even in a case where the character ID of the appearing character determined to execute the sleeping motion by the motion determination section 20 is stored in the user information storing section 266. However, in this case, the amount of reward may be reduced as compared with a case where the character ID is not stored in the user information storing section 266. Furthermore, the reward applying section 32 may apply a reward to the user on the assumption that an appearance character that has slept in a new stance has appeared in a case where stance information indicating a stance determined by the stance determination section 22 is not stored in the user information storing section 266 in association with the character ID of the appearing character determined to execute the sleep motion by the motion determination section 20 even when the character ID is stored in the user information storing section 266.

Note that the reward applied by the reward applying section 32 to the user can be stored in the user information storing section 266 as user information in association with the user ID. The form of the reward is not particularly limited. For example, the reward may be a predetermined point (a research point in an example) or in-game virtual currency, or a coin, a predetermined item, or the like used inside of the game. Also, a method of determining the amount of reward that the reward applying section 32 is to apply to the user is also not particularly limited. For example, it is possible to determine the amount of reward by a variety of methods, such as determining the amount of reward depending on the number of appearing characters that have appeared in the field 100, determining the amount of reward depending on the number of appearing characters that have executed the sleep motion from among the appearing characters, determining the amount of reward depending on the number of characters corresponding to character IDs that are not stored in the user information storing section 266 from among the appearing characters or the appearing characters that have executed the sleeping motion, making determination depending on the amount of reward uniquely associated with the appearing characters or the appearing characters that have executed the sleeping motion, and the like.

### (Hint Generation Section 34)

The hint generation section 34 notifies the user of information related to a motion parameter required to cause the display character to perform another motion that is different from the motion determined by the character determination section 17 and/or a parameter of an object. For example, the hint generation section 34 generates a hint for a parameter required by an appearing character that has left the field without sleeping to execute the sleeping motion or a predetermined motion (for example, any one or more motions from among a plurality of types of sleeping motions (a sleeping posture or a sleeping position, that is a motion in a sound sleep state, a motion in a dozing-off state, and the like)) in the field, that is, a support parameter of an object to be placed and/or arranged in the field. Specifically, the hint generation section 34 acquires information regarding an appearing character determined to perform a motion of leaving the field by the motion determination section 20 (a character that has left, that is, a character that has not slept in the field) from among the appearing characters determined by the appearance determination section 18. Then, the hint generation section 34 acquires a motion parameter stored in the character information storing section 262 in association with an acquired character ID of the leaving character. The hint generation section 34 generates hint information for notifying the user of the type and the amount of the support parameter needed by the leaving character to execute the sleeping motion and/or the predetermined motion in the field using the acquired motion parameter. Note that the hint generation section 34 may not generate the hint information for the appearing character that has been determined by the motion determination section 20 to execute the motion of leaving the field because the appearing character has not been elected in the lottery although the appearing character satisfies the predetermined condition (the condition (a) or (b) in the above explanation). This is because the appearing character has already satisfied the parameter itself which is a condition for executing the predetermined motion in the field.

Then, the hint generation section 34 supplies the generated hint information to the image generation section 24. The image generation section 24 generates a video or a still image in which the received hint information is displayed in a superimposed manner on an image including a clock time at which the leaving motion has been executed. Then, in a case when the image generation section 24 outputs the generated video or still image to the output section 28 in response to a command of the user, the hint information is output together with the video and the still image. Note that in a case where the awakened user has performed field selection to cause the user character and the main character to move a predetermined field and the selected field is a field for which hint has been output once, the output section 28 may output the hint information that has already been output when the field is selected.

### (Image Acquisition Section 36)

The image acquisition section 36 acquires the video generated by the image generation section 24 or at least some of a plurality of frame images (video constituting images) constituting the video in response to a command of the user. The image acquired by the image acquisition section 36 is stored as image data in association with an image ID for identifying the image in the image storing section 270. In other words, the image acquisition section 36 has a function of acquiring a captured image of the video or the still image output from the output section 28.

### (Character Applying Section 38)

In a case where the image generation section 24 generates a video indicating a situation of a field when the user wakes up, the video is output from the output section 28, and the image generation section 24 generates a video of a state where an appearing character that has been sleeping wakes up in the field in response to an input operation of the user, the character applying section 38 allows the user to own the appearing character that has woken up at a predetermined probability. The appearing character that has ended up being owned by the user can be used as a support character in accordance with user's selection. For example, it is assumed that the image generation section 24 has generated a video including the appearing character that is performing the sleeping motion in the field and the video has been output from the output section 28. In this case, the user selects the appearing character that is performing the sleeping motion and is included in the video. The image generation section 24 receives the selection via the input section 10 and generates a video indicating a state where the appearing character that has been performing the sleeping motion wakes up. Then, in a case where the selection is received via the input section 10, the character applying section 38 associates the character ID of the appearing character that has been performing the sleeping motion with the user ID at a predetermined probability (that is, a lottery is drawn). In a case where it is determined that the character ID of the appearing character that has been performing the sleeping motion is to be associated with the user ID at a predetermined probability, the character applying section 38 stores the character ID in the user information storing section 266 in association with the user ID. In this manner, the character that has appeared in the field and has been sleeping ends up being a character owned by the user at a predetermined probability.

### (Experience Value Applying Section 40)

The experience value applying section 40 applies an experience value to the user, the main character, and/or the support character on the basis of sleep information received by the sleep information receiving section 16. The experience value is determined in accordance with the length of the sleep time, for example. Specifically, the experience value applying section 40 adds the experience value determined in accordance with the length of the sleep time to an experience value stored in the user information storing section 266 in association with the user ID and updates the experience value stored in the user information storing section 266 to an experience value after the addition. The experience value applying section 40 also similarly updates an experience value stored in the character information storing section 262 in association with the character ID of the support character and/or an experience value stored in the main character information storing section 265 in association with the character ID of the main character.

### (Level Setting Section 42)

The level setting section 42 compares the experience value of each of the user, the main character, and the support character with a threshold value defined in advance for each of them and raises a level of each of the user, the main character, and the support character in a stepwise manner in a case where the experience value exceeds the threshold value defined in advance. The level setting section 42 can increase the number of items and the types of items that the user can own and can add or increase the types and/or the amount of support parameters of support characters, for example, in accordance with an improvement of level. In an example, in a case where a support parameter of a predetermined character in a “level 1” is a “nice and warm” parameter, the amount thereof is “2”, and the level of the character is turned to a “level 5”, the level setting section 42 can increase the amount of “nice and warm” parameter to “4”, and in a case where the level turns to a “level 10”, the level setting section 42 can execute a change of adding the amount of “nice and warm” parameter to “5” and adding a “sparkling” parameter (the amount of which is, for example, “1”). The level setting section 42 updates the support parameter in the character information storing section 262 to a support parameter after the change.

### (Size Setting Section 44)

The size setting section 44 causes the size of the main character to increase in a stepwise manner in accordance with an increase in level that the level setting section 42 sets. In addition, the size setting section 44 can also cause the size of the main character to increase in accordance with the sleep time received by the sleep information receiving section 16. Furthermore, the size setting section 44 can also cause the size of the main character to increase by providing a predetermined item inside the game to the main character. The size setting section 44 updates information regarding the size stored in the main character information storing section 265 to the size after the increase. Note that the appearance determination section 18 can provide an upper limit for the number of appearance characters to appear in the field in accordance with the level and the size of the main character. Also, the motion determination section 20 can provide an upper limit for the number of appearing characters that perform the sleeping motion in the field in accordance with the level and the size of the main character. In other words, the number of characters that appear in the field, the number of characters that perform the sleeping motion in the field, and/or the size of the characters that can perform the sleeping motion in the field may be increased as the level of the main character is higher or the size thereof is larger. Note that an upper limit may be provided for the size of the main character.

### (Mission Control Section 46)

The mission control section 46 controls, for the user, generation of a mission that can be worked on inside of the game, acquisition of a mission from an external server or the like, and presentation of the generated or acquired mission to the user. In other words, the mission control section 46 presents a mission, a quest, and the like that can be executed by the user inside of the game to the user via the output section 28. The user can execute the game to clear the presented mission, quest, and the like.

### (Support Character Control Section 48)

The support character control section 48 controls motions, growth, and the like of the support character. For example, the support character control section 48 controls motions of the support character in a time (typically during a daytime or in a daytime) except for the sleep time. In an example, a variety of items are present in the field and around the field inside of the game, and the support character control section 48 controls the support character and causes the support character to automatically collect various items. The support character control section 48 stores item IDs of the items collected by the support character in the user information storing section 266 in association with the user ID. Also, the support character control section 48 may cause the support character to grow on the basis of the sleep time received by the sleep information receiving section 16 or a predetermined item (an item such as a tool, a predetermined material, or the like). Note that the growth includes level-up and evolution (the character can change in a stepwise manner using a predetermined material or the like, and such a change will be referred to as “evolution” in the present embodiment) of the support character and the like.

### (Item Control Section 50)

The item control section 50 controls acquisition, utilization, enhancement, and the like of items inside of the game. For example, the item control section 50 controls acquisition of a predetermined item in exchange for in-game virtual currency or a predetermined item by the user in a shop inside of the game, level-up of an item by the user using a predetermined item or a predetermined material, and the like. In a case where the user acquires an item, the item control section 50 stores an item ID of the item in the user information storing section 266 in association with the user ID. Also, the item control section 50 may increase a level of a predetermined item in a case where a predetermined material or the like is applied to the item in response to a command of the user. The item control section 50 changes types and amounts of support parameters in accordance with the level-up of the items, updates the types and the amounts after the change as new support parameters, and stores the new support parameters in the item information storing section 264.

### (Sharing Control Section 54)

The sharing control section 54 receives a command from the user via the input section 10 and supplies a still image, a video, an album, and/or an image stored in the generated image storing section 268 and/or the image storing section 270 to a predetermined server (for example, a server of a social network service (SNS)). Also, in a case where a predetermined command is received via the input section 10 when the output section 28 is outputting a video, the sharing control section 54 may supply video constituting images (frame images) of the video that is being output to the predetermined server. In this manner, a video and a still image including a state where characters are sleeping together with the main character are uploaded onto the predetermined server.

### [Flow of Processing of Game System 1]

FIGS. 5 and 8 illustrate an example of a flow of processing of the game system according to the present embodiment. Note that the order of each step in the following explanation of the flow may be appropriately changed unless contradiction arises in operations of the game system 1. In other words, in a case where one step and a next step after the one step are present, the order of the one step and the next step may be changed, or the one step may be executed before or after yet another step. Note that the same applies to FIGS. 11 and 12.

First, the game includes a plurality of fields. Thus, the game system 1 receives selection of a predetermined field from among the plurality of fields in response to an operation of the user before sleep that is received via the input section 10. Then, the placement receiving section 14 receives a command from the user of placing a predetermined object at a predetermined position in the selected field inside of the game via the input section 10. Then, the placement receiving section 14 places or arranges the object selected by the user at the predetermined position in the field in response to the command (Step 10; hereinafter, Step will be represented as “S”). Objects include items (including consumed items) and support characters, and both the items and the support characters are associated with support parameters. The user hopes that a desired character will appear in the field and perform the sleeping motion, examines a combination of the type and/or the amount of support parameters for each of one or more items and/or one or more support characters, and places or arranges a desired object in the field. For example, the user can devise a combination of objects to be placed or arranged in the field in a variety of manners in accordance with purposes of “being friends with characters that the user himself/herself does not own”, “collecting many characters of a predetermined character type”, and the like. Also, the user can freely place or arrange objects in the field regardless of presence/absence of a specific purpose.

Note that placement locations of items in the field and the number of placed items may differ from the placement locations of the support characters in the field and the number of placed items, respectively. Moreover, the placement location of each of the plurality of items in the field and the number of placed items may also differ for each item, and the placement location of each of the plurality of support characters and the number of placed items may also differ for each support character. Furthermore, the number of items and/or the number of support characters that can be placed may differ for each of the plurality of fields. In other words, the number of items and/or the number of support characters that can be placed in one field may differ from the number of items and/or the number of support characters that can be placed in another field. Also, placement locations of the items and/or placement locations of the support characters may also differ for each of the plurality of fields, and the user may be able to freely select the placement locations. In this manner, it is possible to enable a predetermined number of items and/or support characters to be placed in a first field while enabling more than a predetermined number of items and/or support characters to be placed in a second field, for example.

Note that a character that is supposed to hardly appear in the field (that is, a character that appears at a significantly low probability in the field) may become more likely to appear as compared with a case where no object is arranged, by devising a combination of objects to be placed in the field. However, the appearance probability is preferably set to be lower than the appearance probability of characters that are supposed to appear in the field even if objects are arranged since the character is substantially not supposed to appear in the field. In this manner, if a character of an ice type that is not supposed to appear in a field of a volcano type can appear in the field, and the user can acquire an image in which the character of the ice type is sleeping in the field of the volcano type, for example, the user can considerably enjoy it because the image is rare.

Then, the user goes to bed. In this case, the sleep information receiving section 16 receives a timing for bed of the user (S12). In a case where the information terminal 2 includes an acceleration sensor as the sensor 52, for example, the user places the information terminal 2 near a bedding, a pillow, or the like, and the acceleration sensor detects a predetermined state, such as when the acceleration sensor does not detect any movement of the information terminal 2 for a predetermined period of time, the sleep information receiving section 16 receives a timing at which it is determined that the acceleration sensor has not detected any movement as a timing for bed. Also, the sleep information receiving section 16 may receive, from the user, information indicating that the user will go to bed via the input section 10 when the user gets into bed (for example, the output section 28 is caused to display a “go-to-bed button” or the like, and the user is made to input the fact that the user has gone to bed by pressing the “go-to-bed button”) and receive the timing of the acquisition as the timing for bed. Note that in a case where the sleep information receiving section 16 receives the timing for bed, the image generation section 24 may generate a video indicating a state where the user character and the main character go to bed in the field or a video indicating a state where the user character puts the main character to sleep and then the user character goes to bed, store the video in the generated image storing section 268, and/or cause the output section 28 to output the video.

Subsequently, the user wakes up. In this case, the sleep information receiving section 16 receives a wake-up timing of the user (S14). In a case where the acceleration sensor of the information terminal 2 placed near the bedding, the pillow, or the like by the user detects any movement of the information terminal 2 for a predetermined period of time, for example, the sleep information receiving section 16 receives the timing at which the acceleration sensor detects the movement as the wake-up timing. Also, the sleep information receiving section 16 may receive information indicating that the user has woken up from the user via the input section 10 when the user wakes up (for example, the output section 28 is caused to display a “wake-up button” or the like, and the user is caused to input the fact that the user has woken up by pressing the “wake-up button”) and receive the timing of the acquisition as the wake-up timing. Then, the sleep information receiving section 16 receives a sleep time which is sleep information of the user from the timing for bed and the wake-up timing (S16). Note that in a case where the sleep information receiving section 16 receives the wake-up timing, the image generation section 24 may generate a video indicating a state where the user character wakes up in the field and cause the output section 28 to output the video. Then, the sleep information receiving section 16 may cause the output section 28 to output sleep information of the user at this timing and present the sleep information of the user himself/herself to the user. In addition, in a case where the sleep time calculated from the timing for bed and the wake-up timing received by the sleep information receiving section 16 is less than a specific period of time, the game system 1 may end the processing when the sleep information receiving section 16 receives the wake-up timing (that is, execute a processing of setting the sleep time to zero without drawing a lottery for characters and the like in a later stage).

Note that the sleep information receiving section 16 can set a successive sleep time (for example, 8 hours) with a predetermined length as a received sleep time in a case where the received sleep information is a sleep time. In a case where a sleep time exceeding the sleep time with the predetermined length is received, the sleep information receiving section 16 may round down the time exceeding the sleep time with the predetermined length (that is, the maximum sleep time received by the sleep information receiving section 16 is the sleep time with the predetermined length in this case). In addition, the sleep information receiving section 16 may stop receiving the next sleep information for a predefined period after the successive sleep time (for example, a time that is equal to or less than the sleep time with the predetermined length and is equal to or greater than the specific period of time) is received once.

Next, the character determination section 17 determines a display character to be displayed in the field using the sleep information of the user and parameters of the objects. In this case, when the sleep information receiving section 16 receives the wake-up timing of the user, the character determination section 17 may determine the display character if there is no operation of the user (that is, if there is no predetermined command from the user). Specifically, the appearance determination section 18 and the motion determination section 20 execute the following processing.

First, the appearance determination section 18 determines a character that has appeared in the field (appearing character) and an appearance clock time of the appearing character using the sleep time received by the sleep information receiving section 16 (S18). The appearance determination section 18 determines the type of the character that has appeared in the field by drawing a lottery using the type appearance probability of each character type associated with the field ID of the field with reference to the field information storing section 260. Next, the appearance determination section 18 determines the appearing character that has appeared in the field by drawing a lottery using the character appearance probability of each character for the characters included in the determined character type. The appearance determination section 18 executes the lottery for determining the character type and the lottery for determining the appearing character a number of times determined in accordance with the length of the sleep time.

Note that the appearance determination section 18 may execute the lottery using the character appearance probability of each character without using the type appearance probability associated with the field ID of the field. In this case, the field information storing section 260 stores the character type of the characters that are likely to appear in the field in association with the field ID in advance. Then, the appearance determination section 18 may increase the character appearance probability of the characters of the character type that is likely to appear and is associated with the field ID of the field in advance as compared with character appearance probabilities of characters of other character types, and then execute the lottery.

In addition, the appearance determination section 18 determines a clock time when each appearing character has appeared in the field for each appearing character. The clock time is a clock time between the clock time of the timing for bed and the clock time of the wake-up timing received by the sleep information receiving section 16 (note that the clock time of the timing for bed and the clock time of the wake-up timing may be included). A method of determining the clock time is not particularly limited. For example, the appearance determination section 18 may randomly determine the appearance clock time of the appearing character.

The motion determination section 20 compares motion parameters of the appearing character with object parameters of the objects (that is, the support parameters of the items and/or the support parameters of the support characters) placed or arranged in the field, and determines a motion of the appearing character on the basis of the comparison result (S20). In a case where the types and the amounts of the motion parameters of the appearing character are included in the types and the amounts of the object parameters, the motion determination section 20 determines whether to cause the appearing character to perform a predetermined motion (for example, a sleeping motion) by drawing a lottery. On the other hand, in a case where the types and the amounts of the motion parameters of the appearing characters are not included in the types and the amounts of the object parameters, the motion determination section 20 determines that the appearing character is to execute the motion of leaving the field. Furthermore, in a case where it is determined by drawing a lottery that the appearing character is not to perform the predetermined motion, the motion determination section 20 determines that the motion of leaving the field is to be executed as a motion of the appearing character.

The stance determination section 22 determines a stance of the appearing character that has been determined to perform the sleeping motion by the motion determination section 20 (S22). The stance determination section 22 can determine that the appearing character is to take a stance unique to the field with reference to stance information in association with the field ID of the field, for example. In a case where the field type of the field is a volcano type, for example, the field information storing section 260 can store information indicating that the character takes a sleeping position of sleeping with its stomach exposed as stance information in association with the field ID. In this case, the stance determination section 22 can determine the sleeping position of sleeping with its stomach exposed as the stance of the appearing character that has been determined to perform the sleeping motion with reference to the stance information. Moreover, the stance determination section 22 can also determine the stance of the main character on the basis of the sleep time, quality of the sleep, and the like of the user. Note that the stance determination section 22 may determine the stance by drawing a lottery in a case of determining it.

The image generation section 24 generates an image (for example, a video) indicating a situation of the field including at least either the appearing character that has appeared in the field or the appearing character determined to perform the motion (S24). In other words, the image generation section 24 generates a video appearing as if the video including the state of the character appearing in the field had been taken during the sleep of the user. The image generation section 24 can generate videos in a variety of forms, such as a video for the entire time during which the user sleeps, a video of a digest version including videos at the timing at which the appearing character has appeared during the sleep of the user, a timing at which the appearing character has performed the sleeping motion, and the like, and a video appearing as if the situation of the field had been recorded for each predetermined time during the time of the sleep of the user. The image generation section 24 stores the generated video in the generated image storing section 268.

In addition, in a case where a video including a video at the appearance clock time of the appearing character determined by the appearance determination section 18 and having a predetermined time length before and after the appearance clock time is generated, the image generation section 24 can set a start clock time and an end clock time of the video. In a case where the appearance determination section 18 determines that the appearing clock time of the appearing character is 3:00 AM, for example, the image generation section 24 generates a video including 5 minutes before 3:00 AM and 5 minutes after 3:00 AM, that is, a video having a length from 2:55 AM to 3:05 AM. Then, the image generation section 24 may change a field environment in the video in accordance with the clock time depending on the clock time at which the video is assumed to have been captured, in a case where the video is generated. For example, the image generation section 24 can change the field environment to a night field, a morning glow field, a morning field, a daytime field, or the like in accordance with the appearing clock time of the appearing character determined by the appearance determination section 18 and generate the video.

Note that in a case where the sleep information received by the sleep information receiving section 16 includes quality of the sleep of the user and the video at the time of the appearance clock time of the appearing character is to be generated, the image generation section 24 may display the information related to the quality of the sleep of the user received by the sleep information receiving section 16 together. In this manner, it is possible to recognize what kind of sleeping state (a light sleep state, a deep sleep state, or the like) the user was at the clock time at which a certain appearing character has appeared, for example. Also, S48, which will be described later, may be executed first after S24.

FIG. 6 illustrates an example of a scene of a video generated by the image generation section according to the present embodiment. FIG. 6A is an example of a scene of a video when the user goes to bed, FIG. 6B is an example of a scene of a video after elapse of a predetermined time after the user goes to bed, and FIG. 6C is an example of a scene of a video further after elapse of the predetermined time after the timing of FIG. 6B.

For example, the image generation section 24 generates a video of a state in which the main character 102 is sleeping near the center of the field 100 and an item 104, an item 104a, and a support character 106 are placed or arranged in the periphery thereof immediately after the user goes to bed (or starts to sleep) as illustrated in FIG. 6A. The items and the support character are objects placed or arranged in the field by the user in S10. Note that the video can be output from the output section 28 of the information terminal 2 in response to a command of the user after the user wakes up.

Also, the image generation section 24 generates a video in which the main character 102 is sleeping near the center of the field 100, objects are placed or arranged in the periphery thereof, and further, appearing characters (in the example of FIG. 6B, a character 108 and a character 108a) that are performing the sleeping motion from among the appearing characters appearing in the field 100 are included as illustrated in FIG. 6B as a video after elapse of a predetermined time after the user goes to bed. Then, the image generation section 24 generates a video in which the main character 102 is sleeping near the center of the field 100, the objects are placed or arranged in the periphery thereof, and further, appearing characters (in the example of FIG. 6C, the character 108, the character 108a, a plurality of characters 108b, and a character 108c) that are performing the sleeping motion from among the appearing characters appearing in the field 100 are included as illustrated in FIG. 6C as a video after further elapse of the predetermined time from the timing in FIG. 6B. Note that the example in FIG. 6C illustrates a state where the character 108c is sleeping on the stomach of the main character 102.

Here, the stance determination section 22 may, for example, change the stance of the main character 102 in accordance with the elapse time after the timing for bed of the user and quality (or a sleep stage) of the sleep of the user at the appearance clock time of the character 108b appearing in the field 100 determined by the appearance determination section 18. For example, the stance determination section 22 can change the stance of the main character 102 to a stance of a sound sleep state in a case where the sleep of the user is deep sleep, can slightly change the stance of the main character 102 from the initial stance at the time of arrangement in the field 100 in a case where the sleep of the user is light sleep, and can change the stance of the main character 102 to a stance of sitting upright in a case where the user is in an awakened state. Then, the image generation section 24 may generate a video including the main character 102 in the stance changed by the stance determination section 22 as illustrated in FIG. 6C, for example.

Then, in a case where the video generated by the image generation section 24 includes a character with a character ID that is not stored in the user information storing section 266 in association with the user ID, the character registration section 30 determines that the character is a character that has appeared and slept in the field 100 for the first time (Yes in S26). Then, the character registration section 30 stores the character ID of the character in the user information storing section 266 in association with the user ID. For example, the character registration section 30 registers the character that has appeared in the field 100 in the form of an electronic pictorial book registering characters (S28). Note that the image generation section 24 may generate a video focusing on a situation of the character registered in the user information storing section 266 by the character registration section 30 in the field 100 (that is, a video appearing as if the situation indicating the state of the character appearing and performing the sleep motion in the field 100 had been imaged with the character located at the center).

Then, the reward applying section 32 applies a predetermined reward to the user in a case where an appearing character that has newly appeared and/or an appearing character that has appeared and performed the sleep motion is present in the field 100 (S30). The reward applying section 32 may apply a predetermined reward to the user even in a case where there is no appearing character that has newly appeared and/or an appearing character that has appeared and performed the sleeping motion in the field 100 (No in S26) (S30). Also, the reward applying section 32 may apply a predetermined reward to the user (for example, a mileage) in accordance with the length of the sleep time received by the sleep information receiving section 16. Note that the amount of reward to be applied to the user may be increased in accordance with charging.

Subsequently, the hint generation section 34 determines whether or not there is a character that has left the field 100 without performing the predetermined motion although it has appeared in the field 100 (S32). In a case where it is determined that there is a character that has left (Yes in S32), the hint generation section 34 generates a predetermined hint including information related to the type and/or the amount of support parameters required by the character to execute the predetermined motion (S34).

FIG. 7 illustrates an example of a scene of a video generated by the image generation section and the hint generation section according to the present embodiment.

For example, the hint generation section 34 acquires information regarding the appearing character determined to perform the motion of leaving the field 100 by the motion determination section 20 from among the appearing characters determined by the appearance determination section 18 from the motion determination section 20. Then, the hint generation section 34 acquires motion parameters stored in the character information storing section 262 in association with the character ID of the appearing character. The hint generation section 34 generates hint information indicating the type and the amount of support parameters required by the appearing character to perform the sleeping motion using the acquired motion parameter. Then, the image generation section 24 generates a video including the hint information generated by the hint generation section 34 in a video including a clock time at which the leaving motion of the appearing character has been executed. In an example, the image generation section 24 generates a video including a predetermined image (silhouette of the leaving character or an image of a simple figure or the like from which it is not possible to recognize what character the leaving character is) and including a hint 122 (in the example of FIG. 7, “cute 5 is needed” is displayed) in the vicinity of the image on the region 120 of an appeared position of the leaving character among appeared characters as illustrated in FIG. 7.

Then, after the hint generation section 34 generates the hint, or in a case where the hint generation section 34 determines that there has been no leaving character (No in S32), the image generation section 24 generates a video of the field 100 when the user wakes up in a case where a predetermined command is received via the input section 10 after the user wakes up. Then, the output section 28 outputs the video in response to a predetermined input from the user who has woken up (S36 in FIG. 8).

The user can view the video through the output section 28. Then, in a case where there is a character performing the predetermined motion (for example, the sleeping motion) in the field 100 in the video (Yes in S38), and a user's command of selecting the character in the field 100 is received via the input section 10 (Yes in S40), the image generation section 24 causes the output section 28 to output the video including the state where the selected character is executing a predetermined motion (for example, a waking-up motion) (S42). For example, the image generation section 24 can generate a video displaying the user character in the field and indicating a state where the user character is waking up the character that is performing the sleeping motion and can cause the output section 28 to output the video. Then, the character applying section 38 applies the character that has executed the predetermined motion to the user at a predetermined probability (that is, by drawing a lottery) (S44).

Subsequently, the experience value applying section 40 applies experience values to the user, the main character, and/or the support characters on the basis of the sleep information received by the sleep information receiving section 16 (S46). Also, in a case where there is no character performing the sleeping motion in the field 100 in the video when the user wakes up (No in S38), and in a case where the user's command of selecting the character in the field 100 is not received via the input section 10 (No in S40), the experience value applying section 40 executes the application of the experience values of a predetermined amount (in this case, the experience value applying section 40 may apply experience values of the amount that is smaller than the amount of application of the experience values in S46).

Then, in a case where a predetermined command is received from the user via the input section 10, the output section 28 outputs the video generated by the image generation section 24, the video stored in the generated image storing section 268, and/or a list of characters that have slept in the field 100 during the sleep of the user (S48). The output section 28 can receive a command of outputting the videos and/or a command of outputting the list from the user at any time. In this manner, the user can refer to the appearing characters that have appeared in the plurality of videos, the appearing characters that have performed the sleeping motion, and the list of the motions of the characters and can thus check a result of the game through the list rather than the videos in a case where there is no time after the user wakes up.

FIG. 9 illustrates an example of display of a list of characters according to the present embodiment.

More specifically, the output section 28 can generate and output a list indicating which characters have appeared in the field 100 during sleep of the user on a certain day, when the characters have appeared, and what kind of sleeping positions the characters have been in, on the basis of the determination result of the appearance determination section 18, the determination result of the motion determination section 20, the determination result of the stance determination section 22, and the video generated by the image generation section 24. For example, the output section 28 can output, in a chronological order, a title 124 including a clock time or the like of appearance of the character that has performed the sleeping motion and a sleeping position of the character appearing in the field 100 at the clock time, explanation of the character, and/or an explanatory note 126 regarding a reward and the like applied to the user, a title 124a including a clock time or the like of appearance of a character that has performed the sleeping motion at a clock time after the clock time in the title 124 and a sleeping position of the character appearing in the field 100 at the clock time, explanation of the character, and/or an explanatory note 126a regarding a reward and the like applied to the user as illustrated in FIG. 9. In addition, it is also possible to sum up the number of times the sleeping position of the characters appearing in the field 100 during the sleep of the user has been recorded using the list. Therefore, the user can refer to the total and breakdown of the reward that the user himself/herself has acquired using the list.

Furthermore, in a case where a user's command of selecting a region (for example, a character image displayed at a location adjacent to the explanatory note 126 or the explanatory note 126a) where a character in the list is displayed is received via the input section 10, the output section 28 may replay the video stored in the generated image storing section 268 and generated in regard to the character in the region or a video for a predetermined time including the character in the video. Furthermore, in regard to a character that has not been owned by the user until the previous day from among the characters displayed in the list (that is, a character corresponding to a character ID that is not stored in the user information storing section 266), the output section 28 displays a predetermined mark or the like such that it is not possible to ascertain what kind of character the character is, for example, in the region where the character is supposed to be displayed. Then, the output section 28 can also replay a video including the character in response to a user's command, then delete the predetermined mark or the like, and display the character such that what kind of character the character is in the region where the character is supposed to be displayed.

FIG. 10 illustrates an example of a video selection screen and an image selection screen according to the present embodiment.

The image generation section 24 temporarily stores the generated image in the generated image storing section 268 on the day when the image is generated. A storing period is 24 hours, and the stored image may be deleted after elapse of 24 hours from the storing. Also, in a case where the image is a video, for example, the image generation section 24 causes the output section 28 to output a thumbnail image of each of a plurality of generated videos. In this case, the image generation section 24 may define a clock time determined by the appearance determination section 18 for an appearing character that has performed the sleeping motion from among appearing characters included in one video and that has appeared in the field 100 at the earliest timing in the one video (an actual clock time at which the appearing character has been determined may be used in a case where the appearance determination section 18 determines an appearing character during the sleeping time, or a clock time that is different from the actual time may also be determined as a clock time at which the appearing character is assumed to have appeared in a case where the appearance determination section 18 determines the appearing character every time when the user wakes up) as an imaging clock time of the one video. Then, the image generation section 24 determines the imaging clock time of each video and causes the output section 28 to output the thumbnail image of each video in a chronological manner based on the imaging clock time with reference to the determined imaging clock time. Here, in a case where the actual clock time is used as the imaging clock time determined by the image generation section 24, the imaging clock time is determined as a clock time after the clock time at which the user goes to bed and before the clock time at which the user wakes up. In this manner, it is possible to allow the user to feel as if the character had appeared and slept when the user actually slept.

As illustrated in FIG. 10A, for example, the image generation section 24 aligns the thumbnail image 130 of each of a plurality of videos generated on a predetermined day in a chronological order and causes the output section 28 to output them. Then, the output section 28 can output a video corresponding to a thumbnail selected by the user in response to user's selection of the thumbnail image received via the input section 10. Also, the image generation section 24 can also store the thumbnail image selected by user as an album in the generated image storing section 268 in response to user's selection of the thumbnail image received via the input section 10.

Also, as for the output section 28, it is possible to cause the output section 28 to output album thumbnails 140 of a plurality of albums as illustrated in FIG. 10B. The albums can be categorized in accordance with features of appearing characters and the like that have performed the sleeping motion and are included in the videos or commands of the user. Then, the output section 28 can output a video of an album corresponding to an album thumbnail selected by the user in response to user's selection of the album thumbnail received via the input section 10. Videos stored in the generated image storing section 268 as albums from among the videos generated by the image generation section 24 are not deleted unless the user provides a predetermined command in principle. Therefore, the user can take time to view favorite videos and still images at any time on any day after the user wakes up.

(Flow when User is Awakened)

FIG. 11 illustrates an example of a flow of the game system when the user is awakened. Note that S50 to S60 in FIG. 11 can be executed in this order, some of the steps can be omitted, or an order of one of the steps can be changed to an order before or after another step. In the present embodiment, S50 to S60 will be explained in this order as an example.

After the user wakes up, the game system 1 can automatically execute Steps S18 to S34 (S50). For example, there are not only diurnal characters but also nocturnal characters among the characters. Therefore, the game system 1 automatically executes Steps S18 to S34 in a case where the user is awakened. In other words, the game system 1 executes determination of appearing characters appearing in the field 100, determination of appearing characters that have performed the sleeping motion from among the appearing characters, determination of sleeping postures and the like of the appearing characters that have performed the sleeping motion, generation of videos including the characters that have appeared in the field 100 to sleep when the user is awakened, registration of characters that have newly appeared in the field 100 in the user information storing section 266, applying of a reward to the user, and/or generation of hints related to characters that have appeared but have not performed the sleeping motion and the like when the user is awakened.

Note that in S50, the image generation section 24 generates shorter videos or a smaller number of videos as compared with videos generated when the user is sleeping. Also, the reward applied by the reward applying section 32 to the user and the like is also set to be lower as compared with a reward applied after the sleep of the user. This is because the user is not sleeping in S50.

Also, the support character control section 48 causes the support character to grow on the basis of the sleep time received by the sleep information receiving section 16 (for example, level-up, evolution, and the like of the support character are executed) (S52). For example, the support character control section 48 can cause the support character to grow using an experience value applied to the support character by the experience value applying section 40 in response to the length of the sleep time. Also, the size setting section 44 can cause the main character to grow by increasing the size of the main character on the basis of the sleep time received by the sleep information receiving section 16 (S52). Furthermore, the size setting section 44 can also cause the main character to grow (that is, increase in size) by giving an item (for example, a predetermined nut inside of the game) that is a food of the main character to the main character in response to a user's command received via the input section 10.

Also, the item control section 50 performs enhancement of items owned by the user (that is, items associated with item IDs stored in the user information storing section 266 in association with the user ID) and/or application of a predetermined item to the user (that is, storing of an item ID of the predetermined item in the user information storing section 266 in association with the user ID) in response to a user's command received via the input section 10 (S54). For example, support parameters are associated with items. The item control section 50 can enhance the items by increasing the types and/or the amounts of the support parameters in exchange for consumption of predetermined materials, in-game virtual currency, or the like. Also, the item control section 50 may increase levels of the items owned by the user (that is, increase the types and/or the amounts of the support parameters of the items) in response to the length of the sleep time of the user. Furthermore, in a case where the user owns a predetermined item, the item control section 50 may increase the level of the item in accordance with the number of times the item has been used and/or a utilization time.

Furthermore, the item control section 50 can apply the predetermined item to the user in exchange for consumption of the in-game virtual currency, a reward applied to the user, or the like. For example, the game system 1 can provide an item shop or the like inside of the game, and the user can acquire the predetermined item in exchange for the in-game virtual currency at the item shop. Note that as items, it is possible to use both items that can be used substantially permanently or in a predetermined period of time and items that can be used only a predetermined number of times or either items that can be used substantially permanently or in a predetermined period of time or items that can be used only a predetermined number of times. Also, there may be not only items associated with support parameters but also items that are not associated with support parameters from among the items. The items that are not associated with support parameters may be associated with a function of increasing probabilities in drawing of various lotteries such as a type appearance probability and a character appearance probability of the appearance determination section 18 and/or a probability of being elected of the motion determination section 20, for example. Examples of such items include “incenses”, “accessories”, and the like that predetermined characters like.

In addition, the placement receiving section 14 can organize a deck including a plurality of support characters in response to a user's command received via the input section 10 when the user is awakened (S56). The user can consider a combination of various types of support characters and organize the deck for the purpose of causing a character that is desired to appear in the next sleep to be more likely to appear in the field. In other words, the user can consider a combination of types and amounts of support parameters of one support character and types and amounts of support parameters of another support character and organize a deck in accordance with the user's desired purpose.

Also, the support character control section 48 can cause the support character to automatically execute collection of various items (including a nut or the like that is a food of the main character, for example), materials, and the like in and near the field inside of the game when the user is awakened (S58). In this case, if the placement receiving section 14 has organized the deck of the support characters, the support character control section 48 can collect items and materials by taking advantage of individual properties of the organized support characters.

In addition, the mission control section 46 requests content of play that is required to be achieved inside of the game from the user. Specifically, the mission control section 46 outputs a predetermined mission from the output section 28 such that the user can perceive the mission and sets the predetermined mission as a mission to be achieved by the user in response to a user's command received via the input section 10 (S60). Then, in a case where the user achieves the set mission, the mission control section 46 supplies information indicating that the mission has been achieved to the reward applying section 32. The reward applying section 32 can apply a reward to the user on the basis of the content of the mission and a level of achievement of the mission in accordance with the information. Missions such as a predetermined mission, a sub-mission, a mission in the form of a story, a mission in the form of an event, and the like are exemplified as the missions, and it is possible to appropriately set recording of images of sleeping positions or sleeping postures of predetermined types of characters or recording of images of sleeping positions or sleeping postures of predetermined characters in accordance with a predetermined story, for example.

### (Movement Between Fields)

FIG. 12 illustrates an example of a flow of control processing of the movement control section according to the present embodiment.

The movement control section 12 controls movement of the user character and the main character inside of the map of the game, that is, movement from one field to another field. The movement can be executed at any timing in a time zone when the user is awakened. First, the mission control section 46 generates a predetermined mission for the user and causes the output section 28 to output the mission (S70). The mission is for example, a mission of keeping a sleeping position of a specific character in a video, a mission of moving to a field where a lot of specific characters appear, a mission of moving to a predetermined field and keeping a sleeping position of a predetermined character in a video, a predetermined event, or the like. Therefore, the user character cannot clear the mission in the field where the user character currently stays depending on content of the mission. Thus, the user considers to cause the user character and the main character to move to a field where the user thinks the mission can be cleared and tries to cause the user character and the main character to move to a desired field.

Here, the movement control section 12 can limit the movement of the user character and the main character to once a day in principle. Note that the movement control section 12 may determine elapse of a day using an actual time as a standard or may determine that a day has elapsed in a case where user has continued to sleep for a predetermined time or more after being brought into a sleep state from an awakened state and the user has then been brought into an awakened state. Also, the movement control section 12 can limit a movement distance inside of the map to a field that is adjacent to the field where the user character and the main character currently stay. The user causes the user character and the main character to move to a predetermined field to clear the mission under such limitations. However, there may be a case where the user character and the main character cannot move to a desired field depending on content of the mission that the mission control section 46 causes the output section 28 to present.

Thus, in a case where the state of the main character has been turned to a predetermined state, the movement control section 12 can eliminate the movement limitations imparted on the user character and the main character and allow the user character and the main character to freely move inside of the map in the present embodiment. For example, the movement control section 12 checks whether or not a parameter value indicated by gauge information is the maximum value with reference to the gauge information of the main character (S72). In a case where it is determined that the parameter value is the maximum value (Yes in S72), and a command of causing the user character and the main character to move to the desired field via the input section 10 is received from the user (Yes in S74), the movement control section 12 causes the user character and the main character to move to the desired field (S76). Then, Step S10 or S50 is executed.

On the other hand, in a case where it is determined that the parameter value is not the maximum value (No in S72), or in a case where a command of moving the user character and the main character to move to the desired field is not received from the user via the input section 10 even if the parameter value is the maximum value (No in S74), the movement control section 12 causes the user character and the main character to move to the field that is desired by the user and is adjacent to the current field (S77). Note that the movement control section 12 may cause the user character and the main character to stay in the current field depending on a user's command. Then, Step S10 or S50 is executed.

Note that the item control section 50 can also expand the size of the field in exchange for consumption of the in-game virtual currency. It is possible to increase the number of objects that can be placed or arranged in the field or to increase the numbers of appearing characters to appear in the field and the appearing characters to perform sleeping motion by expanding the field.

### Modification Examples of Embodiment

FIG. 13 illustrates an example of an overview of a part of functional configurations of a game system according to a modification example of the present embodiment. Note that a game system 3 according to the modification example may include all or some of the configurations of the game system 1 explained in FIGS. 2 and 3. Also, since the game system 3 includes configurations and functions that are substantially similar to those of the game system 1 according to the present embodiment, detailed explanation will be omitted except for differences.

The game system 3 according to the modification example of the present embodiment is a game system capable of displaying characters and objects in a field inside of the game selected by a user. Specifically, the game system 3 according to the modification example includes: a storage section 62 that stores a first parameter associated with each of a plurality of fields and a second parameter associated with each of a plurality of objects; a sleep information receiving section 16 that receives sleep information of the user; a receiving section 60 that receives a setting for one field selected from among the plurality of fields and at least one object selected from the plurality of objects in response to a user's operation before sleep; an image generation section 24 that generates a display image indicating a situation of the field including characters on the basis of at least the sleep information of the user, a first parameter associated with the selected field, and a second parameter associated with the selected object; and an output section 28 that outputs the display image after the user wakes up.

### First Modification Example

As a game system 3 according to a first modification example, an example in which the system is configured as a battle game is specifically exemplified. For example, it is possible to configure a game system in which an avatar of the user himself/herself as a character can fight, in a predetermined field, against a counterpart character (an enemy, an enemy monster, or the like) appearing in the field. A field to which the avatar can move is associated with an appearance parameter as a first parameter that is a condition for the counterpart character to appear in the field. Also, the avatar can be equipped with equipment and items such as a sword, a shield, and an armor as objects, and the equipment and the items are associated with a second parameter in the first modification example. In a case where the type and the amount of the first parameter are within a range of the type and the amount of the second parameter, the counterpart character can appear in the field. Note that the second parameter may include a parameter of content of activating a predetermined skill, for example.

First, the storage section 62 stores the first parameter in association with the field ID and stores the second parameter in association with the object ID. Then, the receiving section 60 receives selection of one field from among the plurality of fields and sets the received field as a field where the game is executed in response to a user's operation before sleep. In addition, the receiving section 60 receives a setting of objects such as equipment and items used by the avatar of the user in the one selected field.

Then, the image generation section 24 generates a display image including the counterpart character determined to appear in the field using the sleep information of the user received by the sleep information receiving section 16, the first parameter, and the second parameter and the avatar of the user and including a fighting scene of the counterpart character and the avatar. Note that the number of times the counterpart character appearing in the field is being elected, the level of the counterpart character, and the like may be determined on the basis of the sleep information (for example, a sleep time) of the user.

In this case, the image generation section 24 generates the display image including a fighting scene of the counterpart character and the avatar equipped with equipment and items. The display image including the fighting scene is a display image including a situation of a scene in which the avatar defeats the counterpart character, a scene in which the avatar is defeated by the counterpart character, a scene in which the content of the fighting between the avatar and the counterpart character is good fight, or the like on the basis of a correspondence between the counterpart character and the avatar equipped with the equipment and the like. Then, the output section 28 outputs the display image generated by the image generation section 24 to a display section or the like of an information terminal.

In the first modification example, the user can cause the avatar of the user himself/herself and the counterpart character to fight in the battle game merely by sleeping, the counter character appearing in the field changes in various manners depending on the equipment, and the content of fighting also varies in various manner in accordance with the change, and the user can thus wake up while being excited about what kind of fighting will take place.

### Second Modification Example

As a game system 3 according to a second modification example, an example in which the system is configured as a farm game is specifically exemplified. For example, it is possible to configure the game system in which vegetables as characters in a predetermined field grow in a vinyl greenhouse, a field of rice or other crops, or the like in the field. The field is associated with a first parameter which is a condition that determines what kinds of vegetables are grown. Also, objects in the second modification example are, for example, a vinyl greenhouse that can be placed in the field, heating equipment, cooling equipment, a scarecrow, a fertilizer, and the like, and the objects are associated with a second parameter. In a case where the type and the amount of the first parameter are within a range of the type and the amount of the second parameter, the vegetables determined by the first parameter can grow in the vinyl greenhouse or the like in the field.

First, the storage section 62 stores the first parameter in association with the field ID and stores the second parameter in association with the object ID. Then, the receiving section 60 receives selection of one field from among the plurality of fields and sets the received field as a field where the game is executed in response to a user's operation before sleep. In addition, the receiving section 60 receives a setting of objects such as the vinyl greenhouse, the fertilizer, and the like used to grow the vegetables in the one selected field.

Then, the image generation section 24 generates a display image including vegetables that have been determined to grow in the field using the sleep information of the user received by the sleep information receiving section 16, the first parameter, and the second parameter and indicating a state where the vegetables grow. Note that the number of times the vegetables are elected to determine vegetables to be grown in the field, the growth speed of the vegetables, and the like may be determined depending on the sleep information (for example, a sleep time) of the user. In this case, the image generation section 24 generates a display image including the vegetables (for example, vegetables and the like that have grown in the vinyl greenhouse or the like) that have grown in the field, a state of growth of the vegetables, and the like. Then, the output section 28 outputs the display image generated by the image generation section 24 to a display section or the like of an information terminal.

In the second modification example, the user can cause the vegetables to grow in the farm game merely by sleeping, and the vegetables to be grown change in various manners depending on the objects to be placed in the field, and the user can thus wake up while being excited about what kinds of vegetables will grow.

### Third Modification Example

As a game system 3 according to a third modification example, an example in which a system is configured as an amusement park game is specifically exemplified. For example, it is possible to configure a game system in which guests that come to a predetermined amusement park as characters in a field of the amusement park play in a ferris wheel, a roller coaster, and the like in the amusement park. The field of the amusement park is associated with a first parameter (appearance parameters of the guests) which is a condition determining what kinds of guests will come to the amusement park. Also, objects are, for example, the ferris wheel, the roller coaster, a merry-go-round, a haunted house, and the like that can be placed in the amusement park in the third modification example, and the objects are associated with a second parameter. In a case where the type and the amount of the first parameter are within a range of the type and the amount of the second parameter, the guests determined by the first parameter play in the ferris wheel and the like in the amusement park.

First, the storage section 62 stores the first parameter in association with the field ID and stores the second parameter in association with the object ID. Then, the receiving section 60 receives selection of one field from among the plurality of fields and sets the received field as a field where the game is executed in response to a user's operation before sleep. In addition, the receiving section 60 receives a setting of the objects such as the ferris wheel, the roller coaster, and the like to be placed in the one selected field.

Then, the image generation section 24 generates a display image including the guests that have been determined to come to the field using sleep information of the user received by the sleep information receiving section 16, the first parameter, and the second parameter and indicating a state where the guests play in a predetermined facility in the amusement park. Note that the number of times guests are elected to determine guests to come to the amusement park, rareness of the guests, and the like may be determined by the sleep information (for example, a sleep time) of the user. In this case, the image generation section 24 generates the display image including the guests who have come to the field (that is, the amusement park), the state where the guests are playing, and the like. Then, the output section 28 outputs the display image generated by the image generation section 24 to a display section or the like of an information terminal.

In the third modification example, the user can cause various guests to visit the amusement park in the amusement park game merely by sleeping, the guests coming to the amusement park change in various manners depending on the objects to be placed in the field, and the user can thus wake up while being excited about who will come (or have come) to the night amusement park as guests.

### Advantageous Effects of Embodiment

The game system 1 according to the present embodiment can determine characters appearing in the field using the sleep time of the user, the parameters of the fields, and the parameters of the objects, determine characters that perform a predetermined motion such as a sleeping motion, and generate a video including a state in which the characters are performing the predetermined motion such as the sleeping motion in the field. Then, the user can view the video after the user wakes up. Therefore, according to the game system 1, the user can view videos of a state different from that of the previous day every time the user wakes up in the morning. Also, since the content displayed in the video also changes in accordance with the length of the sleep time, it is possible to provide contradictory playability by causing the user to “hope to wake up early to view the video” and also to “hope to get more achievements by sleeping longer” every morning. In this manner, the game system can provide a game (that is to say, a game that enables the user to actively wake up) that allows the user to look forward to waking up.

For example, according to the game system 1, the user can go to bed while looking forward to what kinds of characters will come in the field the next morning and can thus look forward to waking up in the morning. Furthermore, it is possible to provide a pleasure that the user himself/herself may be able to own the characters visiting the field, a pleasure of checking the video to know what kinds of characters have appeared and slept in the field, and further, a pleasure that the user can view the field of a state that is different from the field in the previous morning every day.

Furthermore, according to the game system 1, the number of characters visiting the field to sleep also increases in accordance with the size of the main character if the main character grows depending on the sleeping time and the size of the main character increases through the growth, and it is thus possible to give a feeling of desire to get up early and observe the field and a feeling of desire to have a longer sleeping time, which are feelings that are mutually contradictory, and to allow the user to further enjoy the game. In addition, according to the game system 1, the user can check the video including the characters that have appeared in the field and the characters that have slept during the sleep of the user at any time when the user wakes up. In this manner, the user can enjoy observation of modes of lives of the characters such as how the characters live in the nighttime, how the characters sleep, and the like.

Furthermore, according to the game system 1, the user can acquire research points, in-game virtual currency, or the like by registering the characters that have slept in the field and sleeping postures or sleeping positions of the characters in the “pictorial book” and use the acquired research points or the in-game virtual currency for various purposes inside of the game, and it is thus possible to provide various ways to enjoy the game in relation to the sleep. Also, according to the game system 1, it is only necessary for the user to sleep, the game system 1 executes the game merely by acquiring the sleep time of the sleep, and thus game elements such as complicated operations are not required, and everybody can enjoy the game focusing on the sleep regardless of ages and sexes.

### [Game Program]

Each of the constituent components included in the game system 1 according to the present embodiment shown in FIGS. 1 to 13 can be realized by having a calculation processing device such as a central processing unit (CPU) execute a program (in other words, a game program), or in other words by means of processing executed using software. Alternatively, the constituent components can be realized by writing the program into hardware serving as an electronic component, such as an integrated circuit (IC), in advance. Note that software and hardware can also be used in combination.

The game program according to the present embodiment can be incorporated into an IC, a ROM, or the like in advance, for example. In addition, the game program can be recorded as a file with an installable format or an executable format in a computer-readable recording medium such as a magnetic recording medium, an optical recording medium, or a semiconductor recording medium to be provided as a computer program. The recording medium storing the program may be a non-transitory recording medium such as a CD-ROM or a DVD. Furthermore, the game program can be stored in advance in a computer connected to a communication network such as the Internet, and can be provided by being downloaded through the communication network.

The game program according to the present embodiment is adapted to work on the CPU and the like to cause the game program to function as the input section 10, the movement control section 12, the placement receiving section 14, the sleep information receiving section 16, the character determination section 17, the appearance determination section 18, the motion determination section 20, the stance determination section 22, the image generation section 24, the storing unit 26, the output section 28, the character registration section 30, the reward applying section 32, the hint generation section 34, the image acquisition section 36, the character applying section 38, the experience value applying section 40, the level setting section 42, the size setting section 44, the mission control section 46, the support character control section 48, the item control section 50, the sensor 52, the sharing control section 54, the receiving section 60, the storage section 62, the field information storing section 260, the character information storing section 262, the item information storing section 264, the main character information storing section 265, the user information storing section 266, the generated image storing section 268, and the image storing section 270 explained in FIGS. 1 to 13.

While an embodiment of the present disclosure has been described above, the embodiment described above is not intended to limit the disclosure as set forth in the scope of claims. In addition, it should be noted that not all combinations of features described in the embodiment are essential as solutions to the problem addressed by the disclosure. Furthermore, technical elements of the embodiment described above can be applied independently or applied by being divided into a plurality of units such as program components and hardware components.

### REFERENCE SIGNS LIST

1, 3 Game system
2 Information terminal
10 Input section
12 Movement control section
14 Placement receiving section
16 Sleep information receiving section
17 Character determination section
18 Appearance determination section
20 Motion determination section
22 Stance determination section
24 Image generation section
26 Storing unit
28 Output section
30 Character registration section
32 Reward applying section
34 Hint generation section
36 Image acquisition section
38 Character applying section
40 Experience value applying section
42 Level setting section
44 Size setting section
46 Mission control section
48 Support character control section
50 Item control section
52 Sensor
54 Sharing control section
60 Receiving section
62 Storage section
100 Field
102 Main character
104, 104a Item
106 Support character
108, 108a, 108b, 108c Character
110 Serial number
112 Name
114 Image
116 Type name
118 Number of times of imaging
120 Region
122 Hint
124, 124a Title
126, 126a Explanatory note
130 Thumbnail image
140 Album thumbnail
260 Field information storing section
262 Character information storing section
264 Item information storing section
265 Main character information storing section
266 User information storing section
268 Generated image storing section
270 Image storing section

1. A game system in which a character is able to appear in a field inside of a game, the game system comprising:
processing circuitry configured to
receive sleep information of a user,
receive a setting of an object that is able to be placed in the field and is associated with a parameter in response to an operation of the user before sleep,
determine a display character that is a character to be displayed in the field on the basis of at least the sleep information of the user and the parameter of the object,
generate a display image indicating a situation of the field including the object placed in the field and the display character, and
output the display image after the user wakes up.

2. The game system according to claim 1,
wherein the sleep information of the user used to determine the display character includes at least information related to a sleep time and does not include information related to quality of sleep,
wherein the processing circuitry is further configured to
generate a video as the display image and generate the video with a length determined in accordance with the sleep time,
and
associate information related to the display character included in the video for the first time with the user.

3. The game system according to claim 1, wherein the processing circuitry is further configured to
determine an appearing character that is a character appearing in the field on the basis of the sleep information of the user, and
compare the parameter of the object with a parameter of the appearing character and determine a motion of the appearing character on the basis of a comparison result,
and
wherein a display mode of the display character is determined on the basis of information regarding the appearing character and information regarding the motion of the appearing character.

4. The game system according to claim 1, wherein the processing circuitry is further configured to
determine a clock time at which the display character has appeared in the field on the basis of the sleep information.

5. The game system according to claim 1,
wherein the field is selected in accordance with the operation of the user before sleep from among a plurality of fields, and the field is associated with each character that is able to appear in the field, and
the processing circuitry is further configured to
determine the display character on the basis of at least the sleep information of the user, the parameter of the object, and a parameter of the character associated with the field.

6. The game system according to claim 1,
wherein the character is associated with a motion parameter that is a condition required for the character to execute any one motion from among a predetermined plurality of types of motions in the field, and
the processing circuitry is further configured to
compare the parameter of the object with the motion parameter of the display character and determine the motion of the display character, and
notify the user of information related to at least either the motion parameter or the parameter of the object required to cause the display character to execute another motion that is different from the motion determined by the character determination section.

7. The game system according to claim 6, wherein the motion of the display character includes a plurality of types of motions of sleeping in the field and at least one motion of waking up in the field.

8. The game system according to claim 1,
wherein the user character of the user is able to act in the field together with a main character that is able to act in the field together with the user character in the game, and
the display character executes a sleeping motion at a position within a predetermined range centered on the main character.

9. A game method in a game system in which a character is able to appear in a field inside of a game, the game method comprising the steps of:
receiving sleep information of a user;
receiving a setting of an object that is able to be placed in the field and is associated with a parameter in response to an operation of the user before sleep;
determining a display character that is a character to be displayed in the field on the basis of at least sleep information of the user and the parameter of the object;
generating a display image indicating a situation of the field including the object placed in the field and the display character; and
outputting the display image after the user wakes up.

10. A non-transitory computer-readable storage medium storing computer-readable instructions thereon which, when executed by a game system in which a character is able to appear in a field inside of a game, the causes the game system to perform a method, the method comprising:
receiving sleep information of a user;
receiving a setting of an object that is able to be placed in the field and is associated with a parameter in response to an operation of the user before sleep;
determining a display character that is a character to be displayed in the field on the basis of at least the sleep information of the user and the parameter of the object;
generating a display image indicating a situation of the field including the object placed in the field and the display character; and
outputting the display image after the user wakes up.

11. The non-transitory computer-readable storage medium of claim 10, further comprising:
wherein the sleep information of the user used to determine the display character includes at least information related to a sleep time and does not include information related to quality of sleep,
generating a video as the display image and generate the video with a length determined in accordance with the sleep time; and
associating information related to the display character included in the video for the first time with the user.

12. The non-transitory computer-readable storage medium of claim 10, further comprising:
determining an appearing character that is a character appearing in the field on the basis of the sleep information of the user; and
comparing the parameter of the object with a parameter of the appearing character and determine a motion of the appearing character on the basis of a comparison result,
wherein a display mode of the display character is determined on the basis of information regarding the appearing character and information regarding the motion of the appearing character.

13. The non-transitory computer-readable storage medium of claim 10, further comprising:
determining a clock time at which the display character has appeared in the field on the basis of the sleep information.

14. The non-transitory computer-readable storage medium of claim 10, further comprising:
wherein the field is selected in accordance with the operation of the user before sleep from among a plurality of fields, and the field is associated with each character that is able to appear in the field,
determining the display character on the basis of at least the sleep information of the user, the parameter of the object, and a parameter of the character associated with the field.

15. The non-transitory computer-readable storage medium of claim 10, further comprising:
wherein the character is associated with a motion parameter that is a condition required for the character to execute any one motion from among a predetermined plurality of types of motions in the field,
comparing the parameter of the object with the motion parameter of the display character and determine the motion of the display character; and
notifying the user of information related to at least either the motion parameter or the parameter of the object required to cause the display character to execute another motion that is different from the motion determined by the character determination section.

16. The non-transitory computer-readable storage medium of claim 15, wherein the motion of the display character includes a plurality of types of motions of sleeping in the field and at least one motion of waking up in the field.

17. The non-transitory computer-readable storage medium of claim 10,
wherein the user character of the user is able to act in the field together with a main character that is able to act in the field together with the user character in the game, and
the display character executes a sleeping motion at a position within a predetermined range centered on the main character.

18. A server for a game system in which a character is able to appear in a field inside of a game, the server comprising:
processing circuitry configured to
receive sleep information of a user,
receive a setting of an object that is able to be placed in the field and is associated with a parameter in response to an operation of the user before sleep,
determine a display character that is a character to be displayed in the field on the basis of at least the sleep information of the user and the parameter of the object,
generate a display image indicating a situation of the field including the object placed in the field and the display character, and
output the display image after the user wakes up.
